(19) United States
(12) Patent Application Publication
(10) Pub. No.: US 2021/0345300 A1
(43) Pub. Date: Nov. 4, 2021

(54) NR V2X RESOURCE POOL DEFINITIONS WITHIN A BAND WIDTH PART

(71) Applicant: Fraunhofer-Gesellschaft zur Förderung der angewandten Forschung e.V., München (DE)

(72) Inventors: Sarun SELVANESAN, Berlin (DE); Thomas FEHRENBACH, Berlin (DE); Roya EBRAHIM REZAGAH, Berlin (DE); Cornelius HELLGE, Berlin (DE); Thomas WIRTH, Berlin (DE); Thomas SCHIERL, Berlin (DE); Robin THOMAS, Berlin (DE); Baris GÖKTEPE, Berlin (DE)

(21) Appl. No.: 17/375,569

(22) Filed: Jul. 14, 2021

Related U.S. Application Data
(63) Continuation of application No. PCT/EP2020/050782, filed on Jan. 14, 2020.

(30) Foreign Application Priority Data
Jan. 18, 2019 (EP) 19152641.7

(51) Int. Cl. H04W 72/02; H04W 72/04; H04L 27/26

(52) U.S. Cl. CPC H04W 72/02; H04W 92/18; H04L 27/26025; H04W 72/0453

(57) ABSTRACT

A transceiver for a wireless communication system is described. The wireless communication system provides resources to be allocated for respective transmissions in the wireless communication system. The resources include one or more bandwidth parts, BWPs, a BWP having a certain numerology and including a plurality of subcarriers in the frequency domain. At least one of the BWPs includes a plurality of resource sets for a sidelink communication, the plurality of resource sets including at least a first resource set and a second resource set, the first resource set being associated with a first criterium, the second resource set being associated with a second criterium, and the first criterium and the second criterium being different. The transceiver is configured to use resources from one or more of the plurality of resource sets within the one BWP for a communication.

### CROSS-REFERENCE TO RELATED APPLICATIONS

This application is a continuation of copending International Application No. PCT/EP2020/050782, filed Jan. 14, 2020, which is incorporated herein by reference in its entirety, and additionally claims priority from European Application No. 19152641.7, filed Jan. 18, 2019, which is also incorporated herein by reference in its entirety.

### BACKGROUND OF THE INVENTION

The present invention relates to the field of wireless communication systems or networks, more specifically to the design of resource pools as they may be used in sidelink communications among users of the wireless communication system, for example in V2X applications.

FIG. 1 is a schematic representation of an example of a terrestrial wireless network 100 including, as is shown in FIG. 1(a), a core network 102 and one or more radio access networks RAN₁, RAN₂, . . . RAN_{N}. FIG. 1(b) is a schematic representation of an example of a radio access network RAN. that may include one or more base stations gNB₁ to gNB₅, each serving a specific area surrounding the base station schematically represented by respective cells 106₁ to 106₅. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. Further, some or all of the respective base station gNB₁ to gNB₅ may connected, e.g. via the S1 or X2 interface or the XN interface in NR, with each other via respective backhaul links 116₁ to 116₅, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB) and a system information block (SIB), the physical downlink, uplink and sidelink control channels (PDCCH, PUCCH, PSCCH) carrying for example the downlink control information (DCI), the uplink control information (UCI) and the sidelink control information (SCI). For the uplink, the physical channels may further include the physical random access channel (PRACH or RACH) used by UEs for accessing the network once a UE synchronized and obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix (CP) length. A frame may also consist of a smaller number of OFDM symbols, e.g. when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g. DFT-s-OFDM. Other waveforms, like non-orthogonal waveforms for multiple access, e.g. filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the 5G or NR, New Radio, standard.

The wireless network or communication system depicted in FIG. 1 may by a heterogeneous network having distinct overlaid networks, e.g., a network of macro cells with each macro cell including a macro base station, like base station gNB₁ to gNB₅, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g. GSM, UMTS, LTE base stations.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs are outside of the coverage 200 of a base station, rather, it means that the respective mode 2 UEs are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the mode 1 UEs 202, 204 also mode 4 UEs 206, 208, 210 are present.

In the above-described scenarios of vehicular user devices, UEs, a plurality of such user devices may form a user device group, also referred to simply as group, and the communication within the group or among the group members may be performed via the sidelink interfaces between the user devices, like the PC5 interface. For example, the above-described scenarios using vehicular user devices may be employed in the field of the transport industry in which a plurality of vehicles being equipped with vehicular user devices may be grouped together, for example, by a remote driving application. Other use cases in which a plurality of user devices may be grouped together for a sidelink communication among each other include, for example, factory automation and electrical power distribution. In the case of factory automation, a plurality of mobile or stationary machines within a factory may be equipped with user devices and grouped together for a sidelink communication, for example for controlling the operation of the machine, like a motion control of a robot. In the case of electrical power distribution, entities within the power distribution grid may be equipped with respective user devices which, within a certain area of the system may be grouped together so as to communicate via a sidelink communication with each other so as to allow for monitoring the system and for dealing with power distribution grid failures and outages.

Naturally, in the above-mentioned use cases sidelink communication is not limited to a communication within a group. Rather, the sidelink communication may be among any of UEs, like any pair of UEs.

For the communication among two or more UEs over respective sidelink interfaces a resource pool may be defined. The resource pool includes a plurality of resources that may be used by the UEs for respective transmissions and receptions over the sidelink. In accordance with a conventional approach, for example as defined in the LTE V2X standard, a resource pool is defined as a set of time and frequency resources in the uplink spectrum that are reserved to be used only for vehicular communications.

FIG. 4 illustrates an example of a resource pool which is defined across time and frequency. The top of FIG. 4 illustrates the resources in time and frequency that may be available at the base station for a communication with one or more UEs being connected to the base station. From these available resources a subset of resources is selected for defining the resource pool. As is illustrated in FIG. 4, across the time domain, the base station provides the UE with a subframe bitmap of variable lengths. The bitmap indicates whether resources at a certain time are to be used for the resource pool (indicated by a “1” in the bitmap) and which resources are not to be used for the resource pool (indicated by a “0” in the bitmap). As is indicated by the vertical dotted line in the upper part of FIG. 4, the bitmap may be repeated across the duration of the resource pool. The resource pool includes data and control sub-channels, which are defined on the basis of the subframes indicated by the bitmap and across the frequency. The data sub-channel is defined using a set of parameters that include the number of sub-channels together with a resource block, RB, index, and the size of the sub-channel in RBs. The control sub-channels are defined also on the basis of the subframes indicated in the bitmap, however, only the starting RB index is specified as the control channel extends only across two RBs in frequency. In the example of FIG. 4, one can see that from the block 310 of available resources the resource pool 312 is selected including two control sub-channels 314a and 314b as well as two data sub-channels 316a and 316b. In the example of FIG. 4, the control sub-channels are indicated by specifying the respective starting resource block in each selected subframes, namely the first and sixth RBs in each subframe with a size of 2 RBs in frequency, and the data sub-channels are described by their respective starting RBs, namely the third and eighth RBs in each subframe with a size of three RBs in frequency.

Thus, in accordance with conventional approaches, a resource pool may contain a minimum of two sub-channels, one sub-channel for control information, like the PSCCH, and one sub-channel for data, like the PSSCH. At a given transmit time interval, TTI, or subframe, a transmitting UE broadcasts a sidelink control information, SCI, in the control channel, followed by the data in the same subframe. The SCI will point to the resources within the subframe that data will be transmitted on, and a receiving UE will listen to the control sub-channel so that when it does receive an SCI it is made aware where the data is to be received.

There may be multiple resource pools in each configuration given by the BS to the UEs. Each resource pool may pertain a different purpose or situation, for example, there may be dedicated transmit resource pools, receive resource pools and so-called exceptional resource pools. When considering, for example, the case of transmit resource pools, the base station may divide its coverage area into a plurality of zones and may provide, dependent on the situations in the respective zones, different transmit resource pools for UEs located in the respective zones. For example, the base station may divide the coverage area into eight zones, and FIG. 5 is a schematic representation of a cell, like a cell in the network described above with reference to FIG. 1, in which such a division into multiple zones is applied. The cell is defined by the coverage 200 (see FIG. 3) of the base station gNB. The coverage area 200 is divided into a plurality of zones, each zone having associated therewith a respective zoneID. The coverage area 200 is subdivided into eight zones 200₀ to 200₇ having assigned thereto the zone identifiers zoneID0 to zoneID7. It is noted that FIG. 5 is only an example of how the coverage area 200 may be separated into the respective zones, and in accordance with other examples more or less zones and zones of other shapes may be defined. The respective zones may be defined in relation to respective latitude and longitude coordinates, and the zones may also be referred to as V2X zones for V2X communications. Each of the zones has associated therewith a singular or unique transmit resource pool as is indicated, schematically, at 312. A transmit resource pool for UEs in one zone serve as one of the many receive resource pools for UEs in other zones. The singular exceptional pool is used only during handovers from one base station gNB to another base station gNB by all UEs across zones. The resource pool 312 per zone may indicate for each of the zones the resources allocated for a sidelink communication among UEs, that are located within the zone. UEs within the same zone may have assigned thereto the respective zoneID. The resource pool 312 may indicate, for example, the frequencies/times that may be used by UEs within a given zone for a sidelink communication with other UEs. In accordance with other examples, the coverage area 200 may define a single zone. In case of flying UEs, the zone concept of longitude and latitude can be extended to 3D, e.g. using a height parameter.

Resource pools may be pre-configured in every vehicular modem, and the pre-configured resource pools may be used when the UE is out-of-coverage and has not come into coverage with a base station. In case the UE comes into coverage with the base station, the pre-configuration may be updated, and depending on the status of the UE, connected state or idle state, in or out-of-coverage, a suitable resource pool configuration may be used. FIG. 6 is a diagram illustrating a transmit pool selection for V2X communication. FIG. 6 refers in the lower part to a Mode 3 UE, and a UE is said to operate in mode 3 when the base station eNB schedules the resources to be used within a given resource pool. The UE operates in this mode when being in coverage and in an RRC_CONNECTED state. The upper part of FIG. 6 refers to a Mode 4 UE, and a UE is said to operate in mode 4 when the resource allocation is carried out in a distributed manner by the UE itself. The UE may be either in or out-of-coverage, as well as in either an RRC_CONNECTED or RRC_IDLE state to function in this mode.

A UE, when being in coverage and in an RRC_IDLE state (see block 350), receives at block 352 the SIB21, which contains the information element (IE) SL-V2X-ConfigCommon, which in turn defines the IE V2X-CommTxPoolNormalCommon. This particular IE contains the set of a maximum of 8 transmit resource pool configurations, each of which are defined by the IE SL-CommResourcePoolV2X. The UE also receives the zoneConfig IE which helps the UE in calculating its zoneID (ranges from 0 to 7), and based on the zoneID, selects the singular relevant transmission resource pool from the received set of pools. In the case where the UE does not receive the zoneConfig, it selects the first pool associated with the synchronization reference source. Similarly, when the UE moves on to the RRC_CONNECTED state (see block 354), it receives at block 356 the RRCConnectionReconfiguration message which contains the V2X-CommTxPoolNormalDedicated IE. This IE, provided by the eNB, instructs the UE (see block 358) whether it will receive the exact resources for transmission (eNB scheduled, mode 3) or it has to select its own resources for transmission based on sensing (UE-selected, mode 4). Depending on this selection, the UE is provided with a set of transmission resource pools.

In the scheduled case (see block 360), the UE is provided with the V2X-SchedulingPool IE, which contains the set of a maximum of 8 transmit resource pool configurations, each of which are defined by the SL-CommResourcePoolV2X IE. Based on the zoneConfig IE which helps the UE in selecting the singular relevant transmission resource pool from the received set of pools, the UE selects the relevant transmit resource pool and then transmits based on the resources provided by the eNB (see block 362).

In the UE-selected case, the UE is provided with the V2X-CommTxPoolNormalDedicated IE (see block 364), which then contains the set of a maximum of 8 transmit resource pool configurations, each of which are defined by the SL-CommResourcePoolV2X IE, as described above. The UE also receives the zoneConfig IE which helps the UE in selecting the singular relevant transmission resource pool from the received set of pools. The UE then transmits based on the sensed resources from the selected resource pool (see block 366).

For a UE, when being in out-of-coverage (see block 350), the resource pool is defined according to the SL-V2X-Preconfiguration (see block 368) which is used in block 366 for transmitting.

For a UE, when being in coverage but in the RRC_IDLE state (see block 354), the resource pool is selected from V2X-CommTxPoolNormalCommon defined in the SL-V2X-ConfigCommon (see block 370) which is then used in block 366 for transmitting.

Thus, in the above example, there may be a different configuration provided to a UE, and the UE selects the appropriate transmit resource pool based on the geographical location of the UE, when the coordinates correspond to a single zoneID and a resource pool ID.

The base station may decide whether to assist in the scheduling of resources or if a UE has to select the resources to be used for transmission. This defines the above-mentioned two operational modes of a conventional LTE V2X system, mode 3 and mode 4. As mentioned above, the V2X mode 3 configuration involves the scheduling and interference management of resource by the base station for vehicular UEs within the coverage of the base station so as to enable sidelink communications, like V2X or V2V communications. The control signaling is provided to the UE over the Uu interface, for example using the downlink control indicator, DCI, and resources are dynamically assigned by the base station. In the V2X mode 4 configuration for sidelink communications, the scheduling interference management is autonomously performed using distributed or de-centralized algorithms among the UEs based on a pre-configured resource configuration.

It is noted that the information in the above section is only for enhancing the understanding of the background of the invention and therefore it may contain information that does not form conventional technology that is already known to a person of ordinary skill in the art.

There is a need to provide an improved resource pool design, for example for resource pools to be used in sidelink communications in V2X services in view of the advantages defined by the NR 5G standard.

### SUMMARY

An embodiment may have a transceiver for a wireless communication system, the wireless communication system providing resources to be allocated for respective transmissions in the wireless communication system, wherein the resources include one or more bandwidth parts, BWPs, a BWP having a certain numerology and including a plurality of subcarriers in the frequency domain, at least one of the BWPs includes a plurality of resource sets for a sidelink communication, the plurality of resource sets including at least a first resource set and a second resource set, the first resource set being associated with a first criterium, the second resource set being associated with a second criterium, and the first criterium and the second criterium being different, and the transceiver is configured to use resources from one or more of the plurality of resource sets within the one BWP for a communication.

Another embodiment may have a transceiver for a wireless communication system, the transceiver for serving a plurality of user equipments, UEs, located in a coverage area of the transceiver, wherein the transceiver configures for its coverage area at least one bandwidth part, BWP, having a certain numerology and including a plurality of subcarriers in the frequency domain, the at least one BWP including a plurality of resource sets for a sidelink communication among UEs, the plurality of resource sets including at least a first resource set and a second resource set, the first resource set being associated with a first criterium, the second resource set being associated with a second criterium, and the first criterium and the second criterium being different.

According to another embodiment, a wireless communication system may have: a plurality of the transceivers configured to communicate with each other using a sidelink, SL, and at least one bandwidth part, BWP, having a certain numerology and including a plurality of subcarriers in the frequency domain, the at least one BWP including a plurality of resource sets for the sidelink communication among the transceivers, the plurality of resource sets including at least a first resource set and a second resource set, the first resource set being associated with a first criterium, the second resource set being associated with a second criterium, and the first criterium and the second criterium being different.

According to another embodiment, a wireless communication system may have: one or more base stations, BS, and one or more user equipments, UEs, a UE being configured for a sidelink, SL, communication with one or more other UEs, wherein a base station and/or a UE has a transceiver, wherein the wireless communication system providing resources to be allocated for respective transmissions in the wireless communication system, wherein the resources include one or more bandwidth parts, BWPs, a BWP having a certain numerology and including a plurality of subcarriers in the frequency domain, wherein at least one of the BWPs includes a plurality of resource sets for a sidelink communication, the plurality of resource sets including at least a first resource set and a second resource set, the first resource set being associated with a first criterium, the second resource set being associated with a second criterium, and the first criterium and the second criterium being different, and wherein the transceiver is configured to use resources from one or more of the plurality of resource sets within the one BWP for a communication.

According to still another embodiment, a method for operating a wireless communication system may have the steps of: providing resources to be allocated for respective transmissions in the wireless communication system, wherein the resources include one or more bandwidth parts, BWPs, a BWP having a certain numerology and including a plurality of subcarriers in the frequency domain, providing at least one of the BWPs which includes a plurality of resource sets for a sidelink communication, the plurality of resource sets including at least a first resource set and a second resource set, the first resource set being associated with a first criterium, the second resource set being associated with a second criterium, and the first criterium and the second criterium being different, and using resources from one or more of the plurality of resource sets within the one BWP for the sidelink communication among a plurality of user devices, UEs, of the wireless communication system.

Another embodiment may have a non-transitory computer program product having a computer readable medium storing instructions which, when executed on a computer, perform a method for operating a wireless communication system, the method having the steps of: providing resources to be allocated for respective transmissions in the wireless communication system, wherein the resources include one or more bandwidth parts, BWPs, a BWP having a certain numerology and including a plurality of subcarriers in the frequency domain, providing at least one of the BWPs which includes a plurality of resource sets for a sidelink communication, the plurality of resource sets including at least a first resource set and a second resource set, the first resource set being associated with a first criterium, the second resource set being associated with a second criterium, and the first criterium and the second criterium being different, and using resources from one or more of the plurality of resource sets within the one BWP for the sidelink communication among a plurality of user devices, UEs, of the wireless communication system.

### BRIEF DESCRIPTION OF THE DRAWINGS

Embodiments of the present invention are now described in further detail with reference to the accompanying drawings, in which:

FIGS. 1(a)-1(b) show a schematic representation of an example of a wireless communication system;

FIG. 2 shows a schematic representation of a situation in which UEs directly communicating with each other are in coverage of a base station;

FIG. 3 shows a scenario in which UEs directly communicating with each other are not in coverage of a base station, i.e., are not connected to a base station;

FIG. 4 illustrates an example of a resource pool which is defined across time and frequency;

FIG. 5 is a schematic representation of a cell, like a cell in the network described in FIG. 1, which is divided into multiple zones;

FIG. 6 is a diagram illustrating a transmit pool selection for a V2X communication;

FIG. 7 is a schematic representation of a wireless communication system for communicating information between a transmitter and one or more receivers in accordance with embodiments of the present invention;

FIG. 8 illustrates the activation of BWPs with different numerologies and/or different bandwidth size;

FIG. 9 illustrates an example of bandwidth parts using CORESETs containing user specific and common search spaces;

FIG. 10(a) illustrates an embodiment of multiple NR resource pools for a SL communication, which are defined within a single BWP and which have control regions outside the resource pool;

FIG. 10(b) illustrates a further embodiment of multiple NR resource pools for a SL communication, which are defined within a single BWP and which have control regions inside the resource pool;

FIGS. 11(a)-11(b) illustrate a first embodiment of resource pools designed to be continuous over time and contiguous over frequency;

FIGS. 12(a)-12(b) illustrate a second embodiment of resource pools designed to be continuous over time and non-contiguous over frequency;

FIG. 13 illustrates a third embodiment of resource pools designed to be discontinuous over time and contiguous over frequency;

FIG. 14 illustrates a fourth embodiment of resource pools designed to be discontinuous over time and non-contiguous over frequency; and

FIG. 15 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings in which the same or similar elements have the same reference signs assigned.

The above-described conventional use of resource pools has been initially introduced into the vehicle-to-everything, V2X, specification in release 14 of the 3GPP standard, and the scheduling and assigning of resources are modified according to the V2X requirements while the actual device-to-device, D2D communication standard is used as a basis for the design which is one reason for the maintaining the concept of resource pools. Resource pools were initially designed for D2D communications, bearing in mind the requirements that the resources have to be shared among D2D and cellular communications. In case of V2X communications, a dedicated intelligent transport service, ITS, band is defined that does not share the band of the cellular communications, like the 5.9 GHz band. With the introduction of the frequency range FR1 and FR2, where FR2 is defined up to 52.6 GHz, higher subcarrier spacings or sub carrier spacings, SCSs, for different numerologies may be used. The same applies to possible future frequency ranges above 52.6 GHz, e.g. 60 GHz bands, which will utilize a higher SCS.

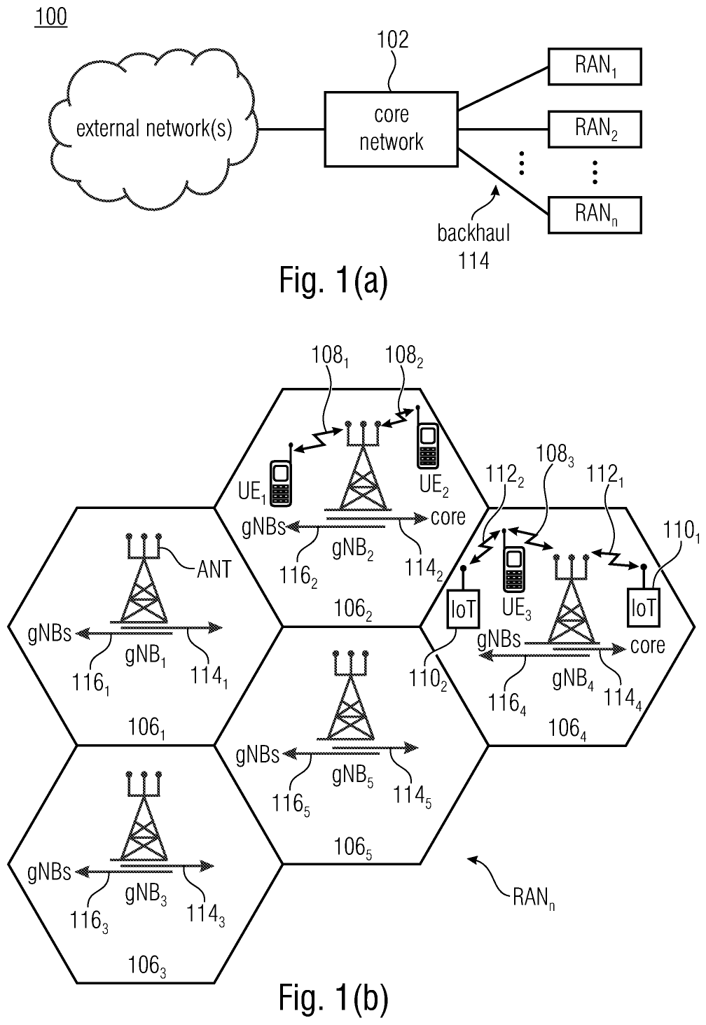

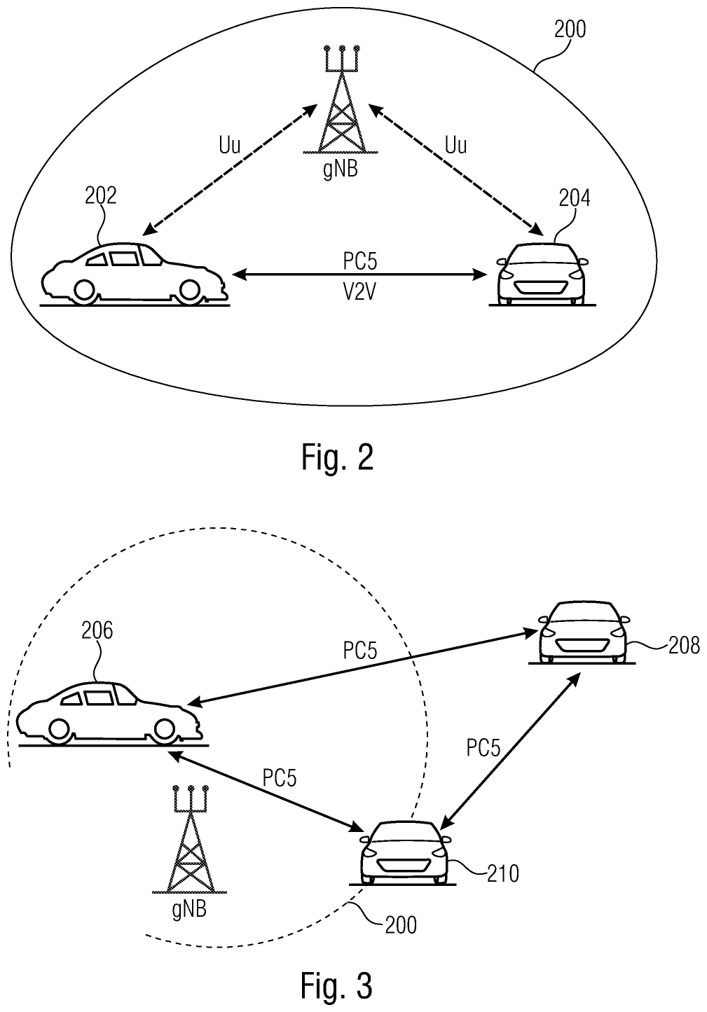

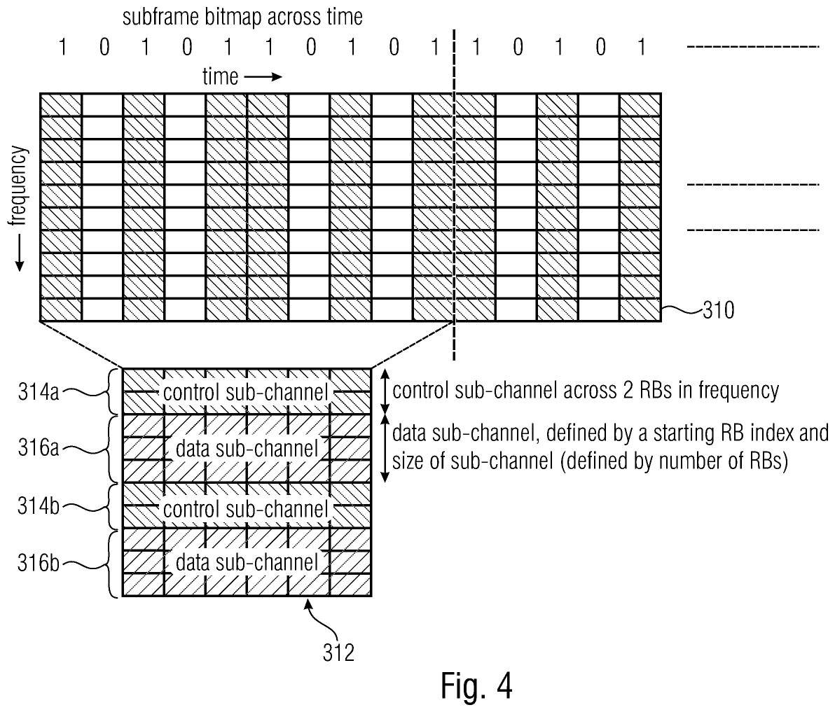

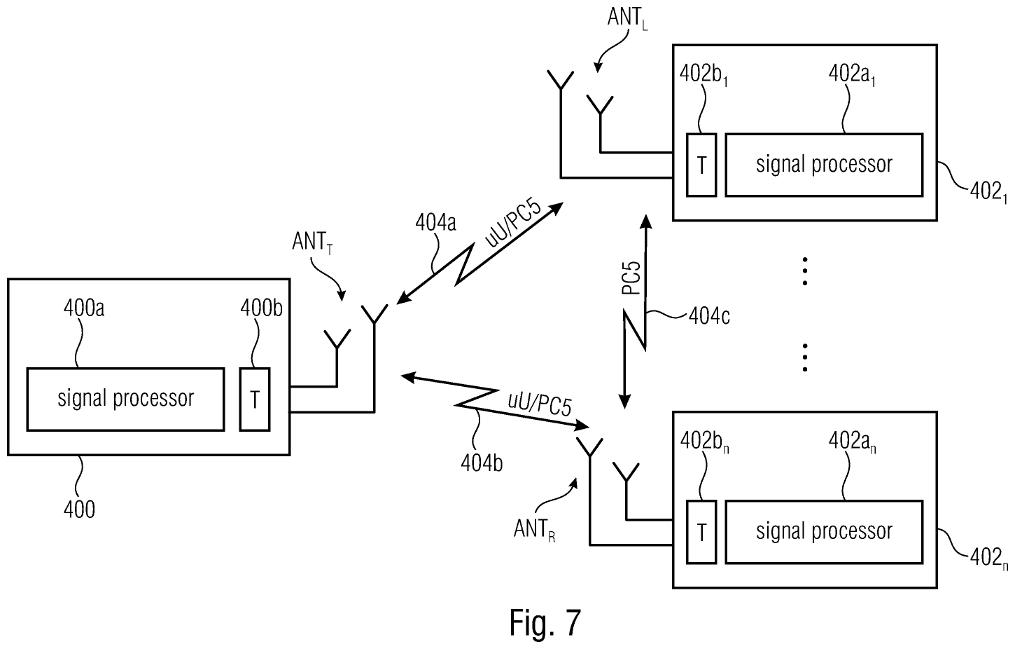

The present invention aims at improving V2X communications using the advantages provided by 5G systems. This is addressed by the present invention as described hereinbelow in more detail, and embodiments of the present invention may be implemented in a wireless communication system as depicted in FIG. 1, FIG. 2 and FIG. 3 including base stations and users, like mobile terminals or IoT devices. FIG. 7 is a schematic representation of a wireless communication system for communicating information between a transmitter 400 and one or more receivers 402₁ to 402ₙ. The transmitter 400 and the receivers 402 may communicate via a wireless communication links or channels 404a, 404b, 404c, like a radio link. The transmitter 400 may include one or more antennas ANT_{T} or an antenna array having a plurality of antenna elements, a signal processor 400a and a transceiver 400b, coupled with each other. The receivers 402 include one or more antennas ANT_{R} or an antenna array having a plurality of antennas, a signal processor 402a₁, 402aₙ, and a transceiver 402b₁, 402bₙ coupled with each other. In accordance with an embodiment, as for example also depicted in FIG. 2, the transmitter 400 may be a base station and the receivers may be UEs. The base station 400 and the UEs 402 may communicate via respective first wireless communication links 404a and 404b, like a radio link using the Uu interface, while the UEs 402 may communicate with each other via a second wireless communication link 404c, like a radio link using the PC5 interface. In accordance with an embodiment, as for example also depicted in FIG. 3, the transmitter 400 may be a first UE and the receivers may be further UEs. The first UE 400 and the further UEs 402 may communicate via respective wireless communication links 404a to 404c, like a radio link using the PC5 interface.

The system, the transmitter 400 and the one or more receivers 402 may operate in accordance with the inventive teachings described herein.

The present invention provides (see for example claim 1) a transceiver for a wireless communication system, the wireless communication system providing resources to be allocated for respective transmissions in the wireless communication system, wherein
the resources include one or more bandwidth parts, BWPs, a BWP having a certain numerology and including a plurality of subcarriers in the frequency domain,
at least one of the BWPs includes a plurality of resource sets for a sidelink communication, the plurality of resource sets including at least a first resource set and a second resource set, the first resource set being associated with a first criterium, the second resource set being associated with a second criterium, and the first criterium and the second criterium being different, and
the transceiver is configured to use resources from one or more of the plurality of resource sets within the one BWP for a communication.

In accordance with embodiments (see for example claim 2) the first and second criteria comprise one or more of the following:
a communication type, e.g. unicast, groupcast/multicast or broadcast,
a traffic type, e.g. aperiodic/one shot or periodic/SPS,
an operation mode, e.g. Mode 1 (in coverage) or Mode 2 (out of coverage),
a QoS requirement, e.g. priority, latency, reliability or communication range,
a zonal location, e.g. zone ID, a geographical grid, routes or special points of interests, like crossings).

In accordance with embodiments (see for example claim 3) a plurality of different resource sets are defined within the one BWP for different communication types having associated therewith different reliability and latency requirements, the communication types including one or more of a broadcast, a groupcast, a multicast or a unicast communication.

In accordance with embodiments, a first resource set is defined within the one BWP for periodic traffic, like a SPS-communication, and a second resource set is defined within the one BWP for aperiodic traffic, like one-shot transmissions.

In accordance with embodiments (see for example claim 4) a first resource set is defined within the one BWP for Mode 1 UEs, and a second resource set is defined within the one BWP for Mode 2 UEs.

In accordance with embodiments, a first resource set is defined within the one BWP for a first QoS requirement, a second resource set is defined within the one BWP for a second QoS requirement, and a third resource set is defined within the one BWP for a third QoS requirement, the first QoS requirement being higher than the second QoS requirement and the second QoS requirement being higher than the first QoS requirement, wherein the QoS requirement may include a priority of the transmission, wherein, optionally, a design of one or more of the resource pools may vary according to the QoS requirements, e.g., control and data resources may be in a TDM or FDM fashion, or according to any one of the designs defined below.

In accordance with embodiments, a plurality of different resource sets are defined within the one BWP for different zones or zonal areas or a geographical grid, routes or special points of interests, like crossings, of the wireless communication system.

In accordance with embodiments (see for example claim 5) the resource sets are defined within the one BWP in one or more of the following manners:
continuous over time and contiguous over frequency,
continuous over time and non-contiguous over frequency,
discontinuous over time and contiguous over frequency,
discontinuous over time and non-contiguous over frequency.

In accordance with embodiments, in case of a resource set being continuous over time and contiguous over frequency, across time the resources, like time slots or subframes, are continuous and adjacent to each other, and across frequency the resources, like resource blocks, RBs, are contiguous and adjacent to each other, wherein the resource set may span an entire duration of the one BWP or a specific time within the one BWP.

In accordance with embodiments, in case of a resource set being continuous over time and non-contiguous over frequency, across time the resources, like time slots or subframes, are continuous and adjacent to each other, and across frequency at least some of the resources, like resource blocks, RBs, are non-contiguous and are not adjacent to each other, wherein the resource set may span an entire duration of the one BWP or a specific time within the one BWP.

In accordance with embodiments (see for example claim 6), in case of a resource set being discontinuous over time and contiguous over frequency, across time at least some of the resources, like time slots or subframes, are discontinuous and are not adjacent to each, and across frequency the resources, like resource blocks, RBs, are contiguous and adjacent to each other.

In accordance with embodiments, in case of a resource set being discontinuous over time and non-contiguous over frequency, across time at least some of the resources, like time slots or subframes, are discontinuous and are not adjacent to each, and across frequency at least some of the resources, like resource blocks, RBs, are non-contiguous and are not adjacent to each other.

In accordance with embodiments (see for example claim 7) some of the resource sets defined within the one BWP partially overlap each other.

In accordance with embodiments (see for example claim 8) the resource sets are defined across time in any one of the following manners:
by a bitmap across time, the bitmap indicating resources, like OFDM symbols or time slots or subframes or frames, where the resource set is defined, spanning either a portion or the entire length of the one BWP,
by a starting resource, like a time slot or a subframe, and a duration of the resource set,
by explicit resources numbers, like time slot or subframe numbers,
by puncturing out resources mentioned explicitly or that are part of another set of resources or RP, and
by a starting resource, and periodic offsets for subsequent occurrences, and the resource sets are defined across frequency in any one of the following manners:
by a bitmap, the bitmap the bitmap indicating resources, like resource blocks, across the one BWP,
by a starting resource, like a resource block, and a number of resources for a resource set,
by multiple starting resources, like resource blocks, and ending resources, if the resource set is non-contiguous over frequency,
by explicit resource indices, like resource block indices,
by puncturing out resources mentioned explicitly or that are part of another set of resources or RP, and
by a starting resource, and periodic offsets for subsequent occurrences.

In accordance with embodiments, the wireless communication system includes a plurality zones or zonal areas, and for a given zone there exists a BWP configuration with the plurality of resource sets defined within the BWP, wherein the transceiver is configured to decide the active BWP by a current zone in which the UE resides and operates, wherein a zone or a zonal area may be, e.g., one or more of the following:
a geographical grid, or
routes, or
special points of interests, like crossings.

In accordance with embodiments, the transceiver is configured to identify a zone associated with the transceiver using a zone ID of a zone, e.g., using a modulo operation, and to identify a resource set from which the resources for the SL communication are scheduled using the zone ID, the number of zones and the number of options for each of the first and second criteria.

In accordance with embodiments, a resource set is identified by a NR zone ID,

NRzoneID=zoneID+numZones*SegregationCriteriaIndex

where
NRzoneID—Zone ID used for NR V2X
zoneID—LTE V2X zone ID
numZones—Number of zones, e.g., 8
SegregationCriteriaIndex—Index for number of options for each of the first and second criteria.

In accordance with embodiments, in case during an ongoing transmission the transceiver changes from a current zone to a new zone, the transceiver is configured to determine the resource sets for the new zone by recalculating the zone ID formula based on its new coordinates, and to use the resources of the previous zone until a timer expires or new resources are given by the gNB, wherein, in case the timer expires, the transceiver may be configured to perform an autonomous resource selection.

In accordance with embodiments (see for example claim 9), in case the transceiver is in-coverage, the transceiver is configured to
receive for all zones a single BWP configuration with all resource sets defined within the one BWP, e.g., using Uu or PC5 RRC signaling, and/or
receive for each zone a BWP configuration with resource sets defined within the one BWP, e.g., using Uu or PC5 RRC signaling, and
   wherein, in case the transceiver is out-of-coverage, the transceiver is configured to retain a last BWP configuration received from a gNB or to revert to a default or hardcoded BWP configuration or to select one of previously retained BWP configurations.

In accordance with embodiments, in case the transceiver is in-coverage, the transceiver is configured to receive a configuration message, e.g., a system information block, including an information element, like a BWP sidelink information element, indicating for all the zones the single BWP configuration or for each zone the respective BWP configuration, each BWP configuration defining the different resources sets across time and frequency within the one BWP and a numerology of the one BWP.

In accordance with embodiments (see for example claim 10), in case the transceiver is out-of-coverage, the transceiver is configured to operate using a BWP pre-configuration defining the different resources sets across time and frequency within the one BWP and a numerology of the one BWP.

In accordance with embodiments, the transceiver comprises a user equipment, UE, the UE configured to operate in accordance with a first mode, for example the V2X LTE Mode 3 or V2X NR Mode 1, for a sidelink communication with one or more other UEs, and in the first mode scheduling of the resources for the sidelink communication with the one or more other UEs is performed by a base station, gNB, of the wireless communication system.

In accordance with embodiments, the transceiver comprise a user equipment, UE, the UE configured to operate in accordance with a second mode, for example the V2X LTE Mode 4 or V2X NR Mode 2, for a sidelink communication with one or more other UEs, and to select resources from the transmit/receive resource set for the sidelink transmission autonomously and/or to signal respective resources on a control channel, e.g. a Physical Sidelink Control Channel PSCCH.

In accordance with embodiments, the resource sets include one or more transmit resource sets and/or one or more receive resource sets, and/or wherein a BWP has a certain duration in time, e.g., includes a plurality of consecutive symbols in the time domain.

In accordance with embodiments (see for example claim 11) a resource set defines a resource pool or a mini-resource pool, wherein a mini-resource pool may define a subpool of the set of resources or RP, the mini-resource pool containing less time and/or frequency resources than a RP.

The present invention provides (see for example claim 12) a transceiver for a wireless communication system, the transceiver for serving a plurality of user equipments, UEs, located in a coverage area of the transceiver, wherein the transceiver configures for its coverage area at least one bandwidth part, BWP, having a certain numerology and including a plurality of subcarriers in the frequency domain, the at least one BWP including a plurality of resource sets for a sidelink communication among UEs, the plurality of resource sets including at least a first resource set and a second resource set, the first resource set being associated with a first criterium, the second resource set being associated with a second criterium, and the first criterium and the second criterium being different.

In accordance with embodiments, the transceiver comprises one or more of a mobile terminal, or stationary terminal, or cellular IoT-UE, or vehicular UE or V2X UE, or an IoT or narrowband IoT, NB-IoT, device, or a ground based vehicle, or an aerial vehicle, or a drone, or a moving base station, or road side unit, or a building, or any other item or device provided with network connectivity enabling the item/device to communicate using the wireless communication network, e.g., a sensor or actuator, or a macro cell base station, or a small cell base station, or a central unit of a base station, or a distributed unit of a base station, or a road side unit, or a UE, or a remote radio head, or an AMF, or an SMF, or a core network entity, or a network slice as in the NR or 5G core context, or any transmission/reception point (TRP) enabling an item or a device to communicate using the wireless communication network, the item or device being provided with network connectivity to communicate using the wireless communication network.

### System

The present invention provides a wireless communication network (see for example claim 13), comprising:
a plurality of the transceivers configured to communicate with each other using a sidelink, SL, and
at least one bandwidth part, BWP, having a certain numerology and including a plurality of subcarriers in the frequency domain, the at least one BWP including a plurality of resource sets for the sidelink communication among the transceivers, the plurality of resource sets including at least a first resource set and a second resource set, the first resource set being associated with a first criterium, the second resource set being associated with a second criterium, and the first criterium and the second criterium being different.

The present invention provides a wireless communication network (see for example claim 14), comprising one or more base stations, BS, and one or more user equipments, UEs, a UE being configured for a sidelink, SL, communication with one or more other UEs, wherein a base station and/or a UE comprises the inventive transceiver.

### Methods

The present invention provides methods for operating wireless communication systems in accordance with the present invention.

The present invention provides a method (see for example claim 15) for operating a wireless communication system, the method comprising:
providing resources to be allocated for respective transmissions in the wireless communication system, wherein the resources include one or more bandwidth parts, BWPs, a BWP having a certain numerology and including a plurality of subcarriers in the frequency domain,
providing at least one of the BWPs which includes a plurality of resource sets for a sidelink communication, the plurality of resource sets including at least a first resource set and a second resource set, the first resource set being associated with a first criterium, the second resource set being associated with a second criterium, and the first criterium and the second criterium being different, and
using resources from one or more of the plurality of resource sets within the one BWP for the sidelink communication among a plurality of user devices, UEs, of the wireless communication system.

### Computer Program Product

The present invention provides a computer program product comprising instructions which, when the program is executed by a computer, causes the computer to carry out one or more methods in accordance with the present invention.

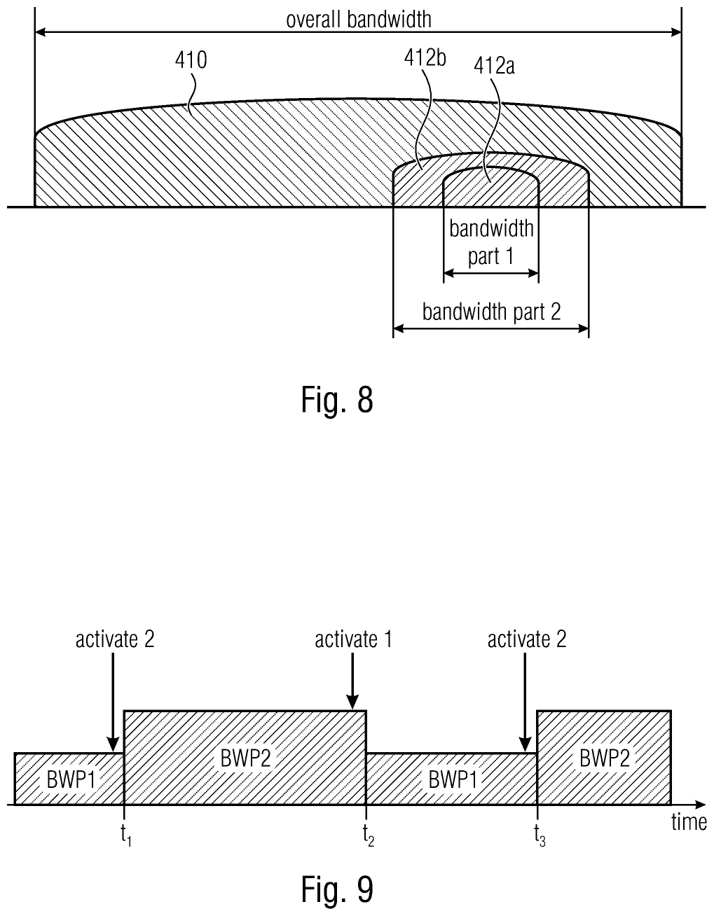

Embodiments of the present invention take advantage of bandwidth parts, BWPs, introduced by NR. Due to the wide bandwidth operation of NR 5G systems, UEs may only be able to transmit and receive in a frequency range which is a subset of the entire bandwidth. The bandwidth may be adapted according to the used throughput which improves the energy efficiency of the system. In particular, a UE may perform decoding only of a smaller part of the entire bandwidth thereby saving energy and thus battery power, especially since the power consumption of an analog-to-digital converter, ADC, scales with the size of the bandwidth. FIG. 8 schematically illustrates the concept of bandwidth parts and illustrates at 410 the overall bandwidth available, as well as two bandwidth parts 412a and 412b having a bandwidth being less than the overall bandwidth 410. Another benefit of the BWP concept is that fast switching between different subcarrier spacings is possible, and that also UEs having only low bandwidth capabilities are supported on wide band carriers. Moreover, load balancing between the overall transmission bandwidth is improved. A BWP includes a set of continuous resource blocks within the entire bandwidth of the system, and each BWP is associated with a specific numerology, like a subcarrier spacing, SCS, and a respective sidelink prefix. A BWP may be equal or larger than the size of a synchronization sequence, SS, block, also referred to as SSB, and may or may not contain the SSB. A UE may have up to four BWPs configured for the downlink and for the uplink each, however, only one BWP for the uplink and for the downlink may be active at a given point in time.

FIG. 9 illustrates the activation of BWPs with different numerologies and/or different bandwidth size. A first bandwidth part BWP1 of a first, lower bandwidth and a second bandwidth part BWP2 of a higher bandwidth is illustrated. Over the time, responsive to a signaling, like the RRC signaling, the respective BWPs may be activated. In the example of FIG. 9, initially, the first bandwidth part BWP1 is active. At a time t₁, the bandwidth part BWP1 is deactivated and the bandwidth part BWP2 of higher bandwidth is activated, by external signaling, as is schematically illustrated in FIG. 9 by the signal “activate2”, meaning that now the bandwidth part BWP2 is to be activated causing a deactivation of the first bandwidth part BWP1. At time t₂ the first bandwidth part is activated once again, and at time t₃ the second bandwidth part is activated again. The durations may be the same or different. A BWP may overlap in frequency or may cover different bandwidths. In the downlink, for switching between BWPs, the receiver is provided with some gap time to allow for retuning of the radio front end, RF, as is illustrated in FIG. 9 where it can be seen, that the respective activate signals are received slightly ahead of the actual switching time t₁, t₂ and t₃.

The BWPs may be configured by RRC signaling, and the activation and deactivation may be enabled by PDCCH signaling. The MAC layer may confirm an activation/deactivation using a MAC control element. Also, a time-based deactivation may be implemented, to reduce the bandwidth once data transmission is completed and to save signaling overhead. The deactivation may also be provided by a MAC control element that is in the last setup packet being transmitted.

By taking advantage of bandwidth part, BWP, concept, embodiments of the present invention provide new approaches for implementing services, like V2X services, meeting meet certain requirements, like an enhanced reliability and a reduced latency under a given quota criteria. Also, multicast/groupcast or unicast communications over a sidelink may be enabled. With the introduction of the frequency range FR1 and FR2, where FR2 is defined up to 52.6 GHz, higher subcarrier spacings, SCSs, for different numerologies may be used, and embodiments of the inventive approach facilitate the use of higher subcarrier spacings in the context of resource pools. The resource pools are basically maintained, however, the resource pools which may be used by a UE at a certain time and/or location for a sidelink, SL, communication are now all within one BWP or within a single BWP having a given numerology. In other words, at a certain time or location only the one or single BW is active and provides resources for the UE for the SL communication. Respective resource pools or resource sets are defined within the one BWP responsive to certain criteria, like certain SL communications the UE participates in. The resource pools, like two, three or more resource pools may have the same size or different sizes, dependent on the resource needs of the communication associated therewith. The resource pools may occupy the entire BWP or only a part thereof. Each resource pool may include transmit and/or resource pools, thereby allowing simultaneous transmission and/or reception. It is noted that a plurality of BWPs may exist in the wireless communication system, e.g., BWPs having different numerologies, and at least some of these BWPs may be used for providing resources for a SL communication. Such BWPs include, as mentioned above, a plurality of resource pools for the SL communication. As mentioned above, however, only one or a single BWP may be used for the SL communication at a given point in time.

In the following reference is made to resource pools. However, the invention is not limited to resource pools, rather the inventive approach is equally applicable to any set of resources. The pool or set of resources may include a plurality of contiguous or non-contiguous resources across a frequency domain and adjacent or non-adjacent across a time domain. Thus, when referring in this specification to a resource pool, this is to be understood also as a reference to a set of resources. A resource set may comprise a plurality of subcarriers in the frequency domain and a plurality of symbols in the time domain, or a number of physical resource blocks, PRBs, each PRB including a set of subcarriers in frequency, and a set of symbols in time domain.

Further, in the following reference is made to one or more zones for which resources may be configured, e.g., a coverage of a gNB may be separated into one or more zones. For example, each zone may include a plurality of transmit/receive resource sets, and each zone is identified by a zone ID. A zone may comprise a 2D or 3D area model to limit signaling overhead, or non-overlapping zones with a defined length and width and height. A zone ID may be reused in space, and the total number of zones may correspond to a used number of resource sets. A UE may determine the zone using a modulo operation. However, the invention is not limited to this concept, rather the inventive approach is equally applicable to any transceiver/system not defining any zones and configuring for a communication a set of resources. Thus, when referring in this specification to a zone this is to be understood also as a reference to the wireless communication system or a transceiver, like a base station, configuring for a coverage area or a cell or multiple cells a set of resources.

In accordance with embodiments, multiple resource pools are may be defined within a single bandwidth part.

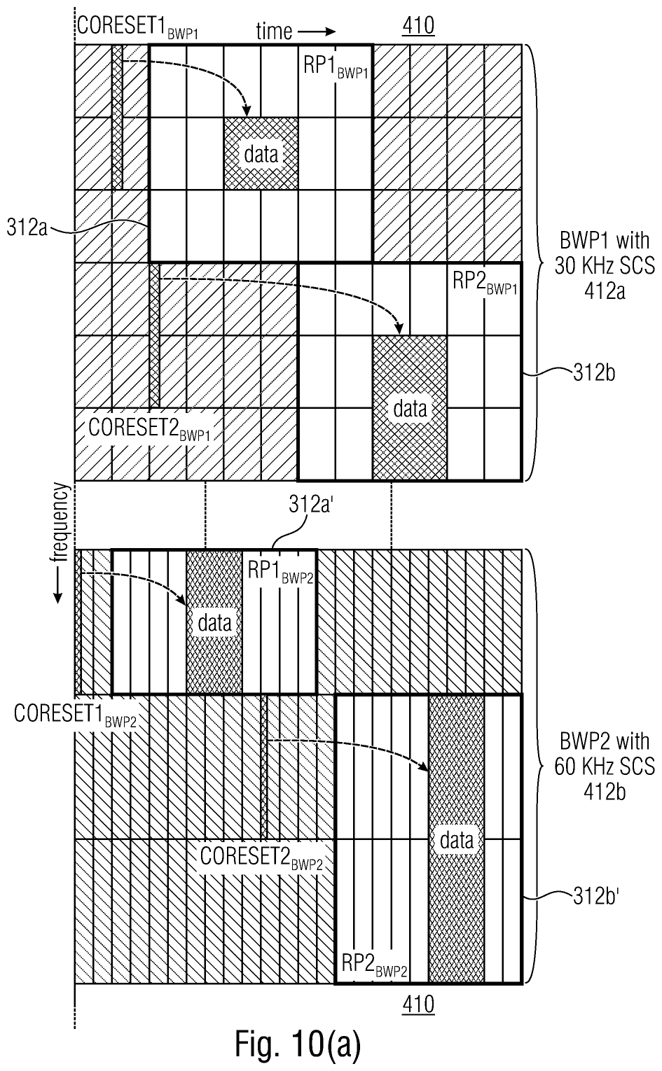

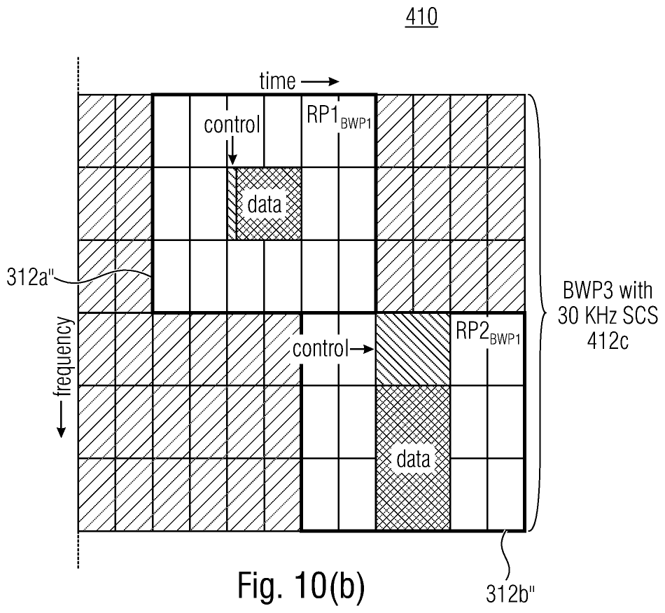

FIG. 10(a) illustrates an embodiment of multiple NR resource pools for a SL communication, which are defined within a single BWP, also referred to as sidelink BWP. This highlights multiple resource pools with the control information residing outside the said resource pools, but within the sidelink BWP. FIG. 10(a), a first bandwidth part 412a having a 30 kHz SCS includes a first resource pool 312a and a second resource pool 312b for a SL communication. In addition, two control resource sets, or CORESETs are provided defining resources where control information is transmitted and includes an indication where the data in the respective resource pools 312a and 312b is found. In other words, a sidelink bandwidth part may contain multiple NR resource pools 312a, 312b within a single BWP. The NR resource pools 312a, 312b may not include dedicated control and data sub-channels, instead, multiple CORESETs may be provided within the BWP corresponding basically to the number of defined resource pools that handle the control and scheduling assignment messages. Further, the control information may point to data which is transmitted/received using the resources inside the selected NR resource pools 312a and 312b. FIG. 10(a) illustrates a second bandwidth part 412b having a numerology different from the first BWP 412a, namely a 60 kHz SCS. The second BWP 412b may define respective pools 312a′ and 312b′. In accordance with other embodiments, the second BWP 412b may define respective pools 312a′ and 312b′ for SL communications. The second BWP 412b may be used instead of the first BWP 412a, e.g., when the environment of the UE or other parameters of the UE of the network changed.

FIG. 10(b) illustrates an embodiment of multiple NR resource pools for a SL communication, which are defined within a single BWP, also referred to as sidelink BWP. This highlights multiple resource pools with the control information residing within the said resource pools. FIG. 10(b) illustrates a third bandwidth part 412c having an SCS of 30 KHz and contains resource pools 312a″ and 312b″, meant for SL communications. In both the resource pools 312a″ and 312b″, the control information is transmitted within the resource pools itself. In the resource pool 312a″, the control and data messages are adjacent in time, in a time-duplexed manner. In resource pool 312b″, the control and data messages are contiguous in frequency, in a frequency-duplexed manner.

In accordance with embodiments, the sidelink BWPs 412 are segregated into multiple (two or more) resource pools based on certain criteria. In other words, the SL resource pools are defined within a single BWP. The segregation of sidelink BWPs 412 into NR V2X Resource Pools may be based on one or more of the following criteria:
a communication type, e.g. unicast, groupcast, multicast or broadcast,
a traffic type, e.g. aperiodic/one shot or periodic/SPS,
an operation mode, e.g. Mode 1 (in coverage) or Mode 2 (out of coverage),
a QoS requirement, e.g. priority, latency, reliability or communication range,
a zonal location, e.g. zone ID, a geographical grid, routes or special points of interests, like crossings).

The segregation may be dependent on the communication types, like broadcast, groupcast, multicast or unicast. For example, each of the communication types has different reliability and latency requirements that have to be adhered to. Defining a resource pool for each of the communication types enable an efficient segregation of resources based on the requirements to be met for the different communications. Broadcast communications may have relaxed reliability and latency requirements as the transmitter UE broadcasts the messages to all the UEs within communication range, and there is no feedback from the receivers that has to be catered to as well. Groupcast and unicast communications may have more stringent requirements. For example, when in case of platooning, which is a use case of groupcast communications, the UEs travel together with very short distances between them. Hence critical messages are to be sent with very low latency to ensure timely reception of the messages, and with high reliability.

The segregation may be dependent on the traffic type, like periodic or aperiodic traffic. The segregation based on traffic types, like periodic (e.g. SPS-like) and aperiodic traffic (one-shot transmissions), enables different procedures to be followed in these resource pools. For example, a UE carrying out sensing in a periodic resource pool may employ only long term sensing (similar to LTE), which efficiently detects the occupancy of resources and predicts the future usage pattern, due to the traffic being periodic in nature. On the other hand, in a resource pool with only aperiodic traffic, either short term sensing (similar to Listen-Before-Talk (LBT)), or a combination of long term and short term sensing procedures may be employed in order to ensure that UEs do not select resources which are already being used by other UEs. Short term sensing is used because the occurrence of aperiodic traffic cannot be predicted, and hence the UEs have to carry of short term sensing before using a resource, in order to ensure that it is not being used by other UEs.

The segregation may be dependent on the operation mode of a UE, and may enable different procedures to be followed in the resource pools. For example, in mode 1 the UE relies on the BS for control information regarding the resource allocations, whereas in Mode 2 the UE autonomously carries out its resource allocations, without the assistance of the BS. A UE may also simultaneously operate in both modes, for example for traffic being generated by different applications. For example, a UE which is a part of a platoon with high QoS requirements may also have broadcast data to transmit. In this case, the UE may choose to carry out its platoon operations with the assistance of the gNB, in a pool designated for Mode 1 operations, and broadcast data in an autonomous manner in a pool assigned for Mode 2 operations.

The segregation may be based on QoS requirements to ensure that QoS requirements of different transmissions by UEs can be met. The resource pools may be segregated into, for example, high, medium and low QoS resource pools. UEs being aware of the QoS being provided by the resources in these resource pools, may efficiently select the relevant pool matching the requirements of the messages to be transmitted best. For example, a design of one or more of the resource pools may vary according to the QoS requirements, e.g., control and data resources may be in a TDM or FDM fashion, as seen in FIG. 10(b), or according to any one of the designs described in more detail below.

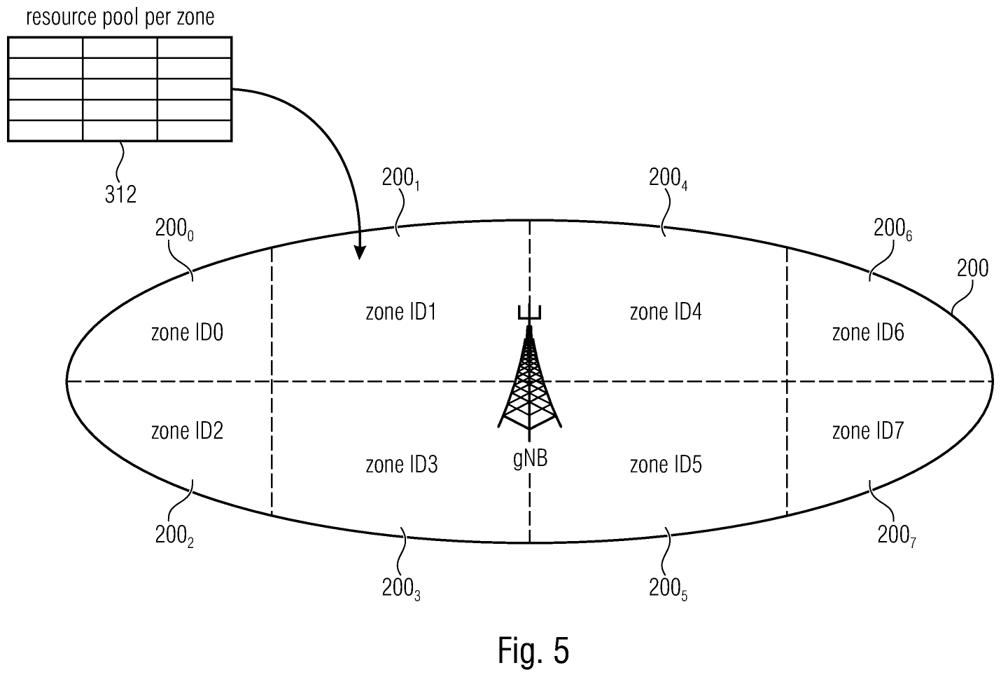

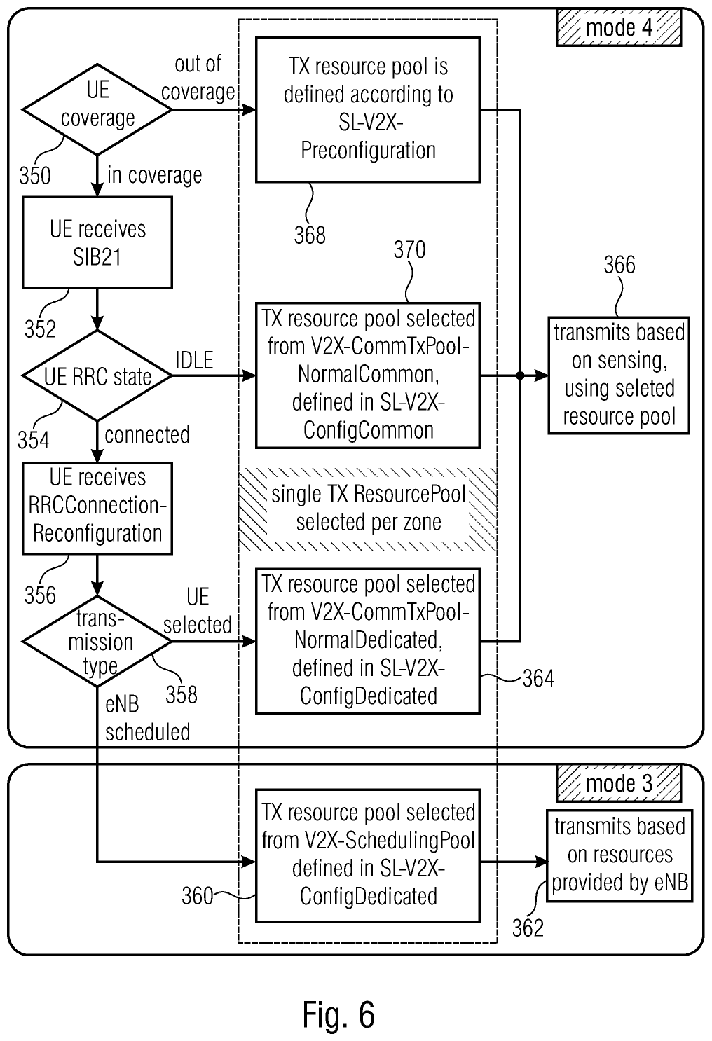

The segregation may be based on zonal location (see FIG. 5). For a given zonal area, there may be resource pools available catering to any of the above options or criteria of segregation. For example, a plurality zones or zonal areas may be provided or defined, and the zone or zonal area may be one or more of the following:
a geographical grid, or
routes, or
special points of interests, like crossings.

For a given BS, there may be a single SL BWP configuration with the plurality of SL resource pools defined within the BWP mapped to different zones within the coverage area of the BS. The UE may decide the relevant resource pool by a current zone in which the UE resides and operates, using, a zone ID formula described, e.g., in EP 18 188 360.3, which is incorporated herewith by reference, and extended as follows. When there are zone IDs 0-7 which correspond to the transmit pools of each zone, the NR zone IDs may be a multiple of the number of options for the criteria listed above.

NRzoneID=zoneID+numZones*SegregationCriteriaIndex

where
NRzoneID—Zone ID used for NR V2X
zoneID—LTE V2X zone ID
numZones—Index for number of zones, e.g., 0-7 for 8 zones
SegregationCriteriaIndex—Index for number of options for each of the first and second criteria.

For example, in case of a segregation dependent on three different communication types, the SegregationCriteriaIndex may be 0 for broadcast, 1 for groupcast and 2 for unicast. Thus, NR zone

IDs 0-7 correspond to the pools of each zone serving broadcast communications, NR zone IDs 8-15 correspond to the pools of each zone serving groupcast and the NR zone IDs 16-23 correspond to the pools of each zone serving unicast communications.

In case during an ongoing transmission a transceiver changes from a current zone to a new zone, the transceiver determines the resource sets for the new zone by recalculating the zone ID formula based on its new coordinates. If the transceiver moves out of the coverage area of the current gNB, it uses the resources of the previous zone until a timer expires. Once the timer expires, if the transceiver has moved into the coverage area of a new gNB, the transceiver will receive the configuration of resource pools for different zones from the new gNB. If the transceiver has not moved into the coverage area of a new gNB, the transceiver can revert to the pre-configured set of resources defined for each zone. Based on the respective configurations, the transceiver determines the resource sets for the new zone by recalculating the zone ID formula based on its new coordinates.

Embodiments for different designs and definitions of NR V2X Resource Pools within a BWP are now described. Different design aspects of the resource pools to be defined within the BWP are described. In accordance with embodiments, resource pools are defined across time and frequency in one of the following ways.

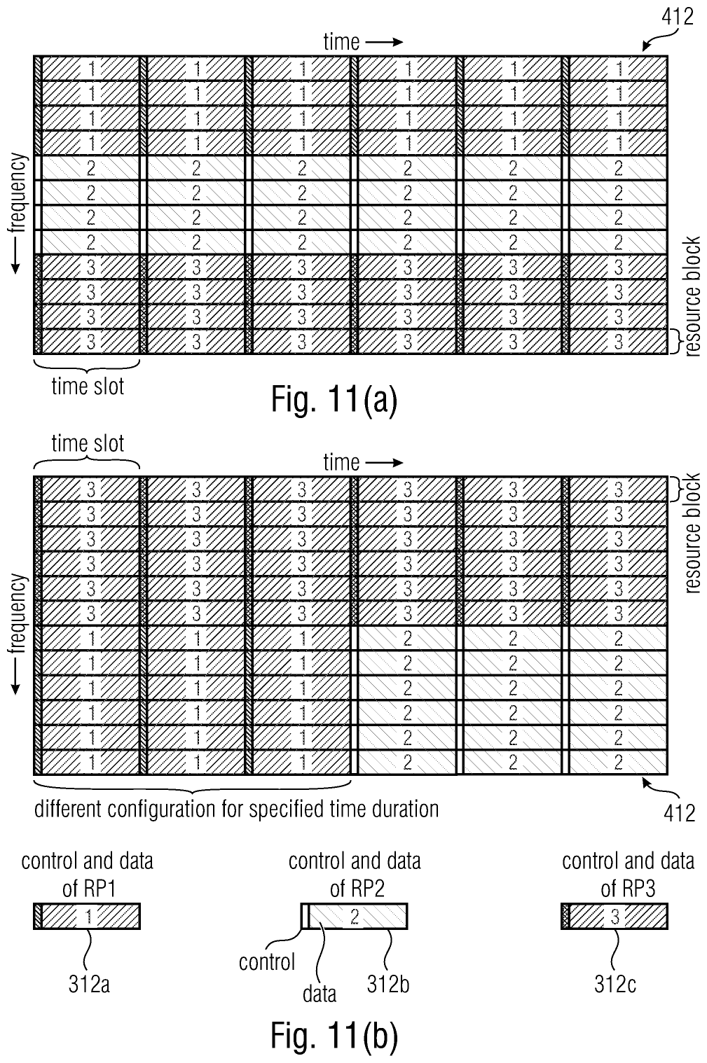

FIG. 11 illustrates a first embodiment of resource pools designed to be continuous over time and contiguous over frequency. FIG. 11 shows a BWP 412 being segregated into three resource pools 312a, 312b and 312c. The resource pools are defined to be continuous across time. This means that the resource pools span the entire duration of the BWP 412, as is shown in FIG. 11(a), or for a specific time within the BWP 412, after which another resource pool may be present, as is shown in FIG. 11(b). Across frequency, the resource blocks (RBs) are contiguous and adjacent to each other for a given resource pool.

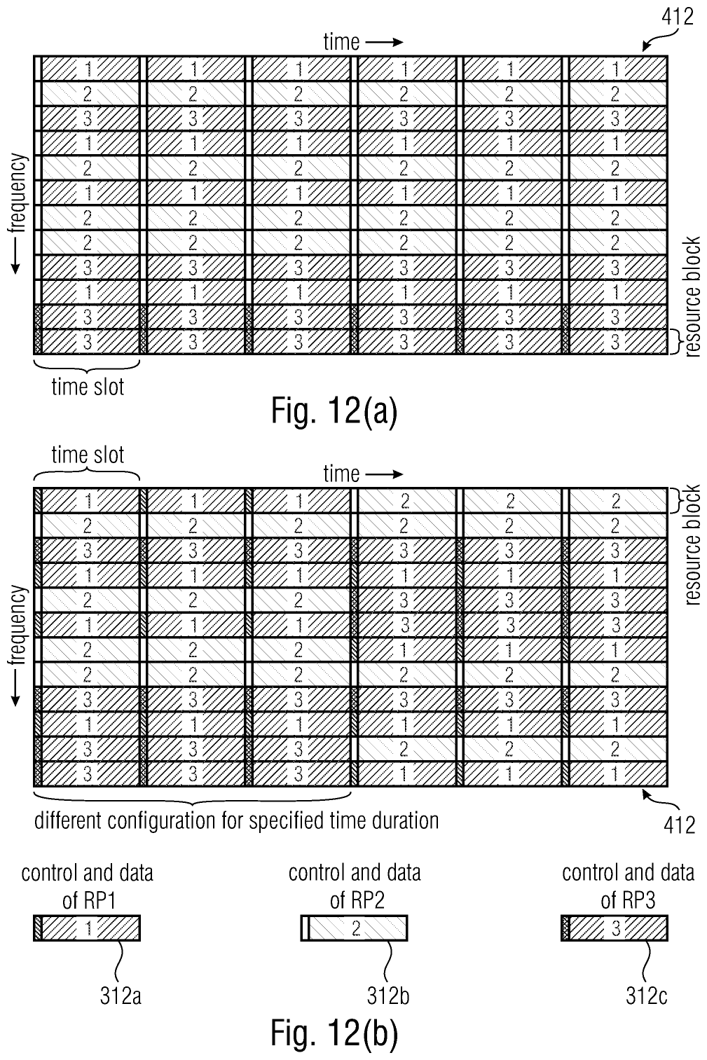

FIG. 12 illustrates a second embodiment of resource pools designed to be continuous over time and non-contiguous over frequency. FIG. 12 shows a BWP 412 being segregated into three resource pools 312a, 312b and 312c. The resource pools are continuous over time spanning the entire duration of the BWP 412, as is shown in FIG. 12(a), or for a specific time within the BWP 412, as is shown in FIG. 12(b), after which another resource pool may be present, similar as in FIG. 11. Across frequency, the resource blocks within the resource pool are non-contiguous and are not adjacent to each other. It is possible for a set of RBs to be adjacent, while others are not. This enables multiple resource pools to be interleaved with each other across frequency.

The designs illustrated in FIG. 11 and in FIG. 12, where the resource pools are continuous across time, have the advantage that a UE may access any of the different types of resource pools at any given point in time. Further, the design of FIG. 12 being non-contiguous in frequency, introduces, in addition, frequency diversity into the resource pool.

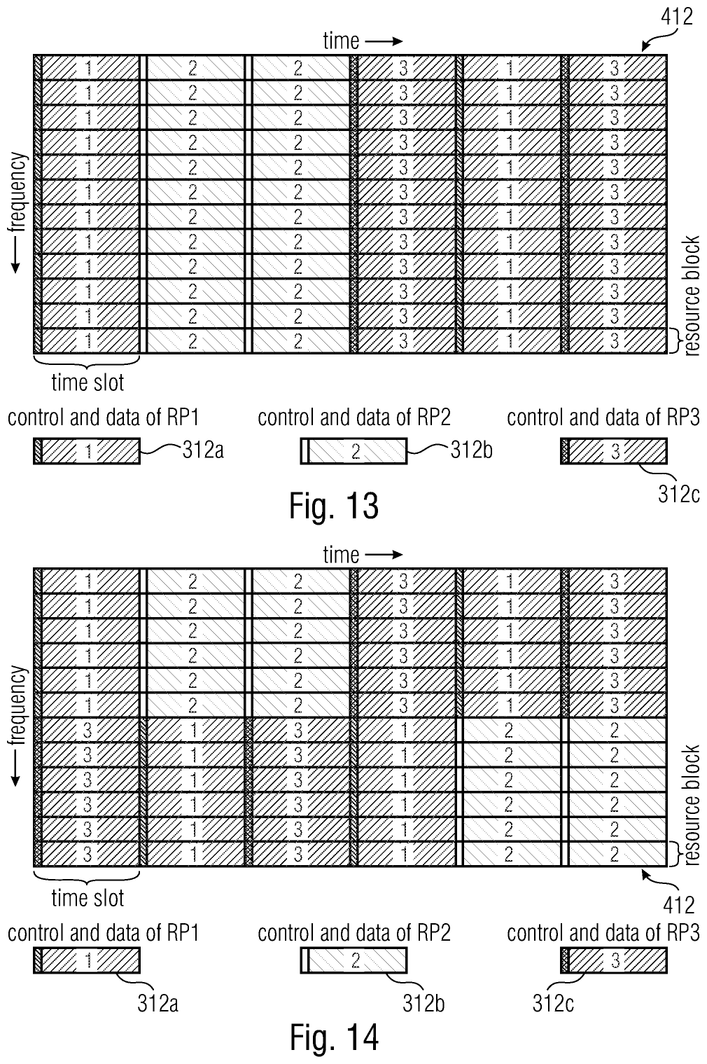

FIG. 13 illustrates a third embodiment of resource pools designed to be discontinuous over time and contiguous over frequency. FIG. 13 shows a BWP 412 being segregated into three resource pools 312a, 312b and 312c. The resource pools are is discontinuous across time, and across frequency the resource blocks (RBs) are contiguous and adjacent to each other for a given resource pool.

FIG. 14 illustrates a fourth embodiment of resource pools designed to be discontinuous over time and non-contiguous over frequency. FIG. 14 shows a BWP 412 being segregated into three resource pools 312a, 312b and 312c. The resource pools are discontinuous across time, as in FIG. 13, and across frequency the resource blocks within the resource pool are non-contiguous and are not adjacent to each other. It is possible for a set of RBs to be adjacent, while others are not. This enables multiple resource pools to be interleaved with each other across frequency.

The designs illustrated in FIG. 13 and in FIG. 14, although there is an additional latency issue because the UEs have to waiting for the instance of a given resource pool to occur, have the advantage that UEs may be able to receive transmissions from other resource pools without being impacted by the half-duplex problem. The latency issue may be further decreased if the resource pool is implemented in a BWP of high SCS. The discontinuity over time is also advantageous when the resource pools have to be defined in a shared carrier where there exists time slots assigned to downlink or uplink transmissions.

The designs illustrated in FIG. 11 to FIG. 14 may be repeated across the length of the BWP. In the embodiments of FIG. 11 to FIG. 14, rather than providing the control data in a CORESET, as in FIG. 10(a), each RB of the resource pool includes, e.g., at its beginning a control part followed by a data part (see, e.g., FIG. 10(b)—RP 312″). In case not all resources in the BWP 412 are occupied by the resource pools, the control data for one or more of the resource pools may be provided as described with reference to FIG. 10(a).

For defining the NR V2X Resource Pools, in accordance with embodiments, the resource pools may be defined across time and frequency in the one BWP as follows:

Across time the resource sets or resource pools, RPs, may be defined in any one of the following manners:
by a bitmap across time, the bitmap indicating resources, like OFDM symbols or time slots or subframes or frames, where the resource set is defined, spanning either a portion or the entire length of the one BWP,
by a starting resource, like a time slot or a subframe, and a duration of the resource set,
by explicit resources numbers, like time slot or subframe numbers,
by puncturing out resources mentioned explicitly or that are part of another set of resources or RP, and
by a starting resource, and periodic offsets for subsequent occurrences.

Across frequency the resource sets or resource pools, RPs, may be defined in any one of the following manners:
by a bitmap, the bitmap the bitmap indicating resources, like resource blocks, across the one BWP,
by a starting resource, like a resource block, and a number of resources for a resource set,
by multiple starting resources, like resource blocks, and ending resources, if the resource set is non-contiguous over frequency,
by explicit resource indices, like resource block indices,
by puncturing out resources mentioned explicitly or that are part of another set of resources or RP, and
by a starting resource, and periodic offsets for subsequent occurrences.

Embodiments for the configuration and signaling of NR V2X Resource Pools within a single BWP are now described. More specifically, embodiments how the resource pools may be defined, pre-configured and signaled are described. Since the resource pools exist within the BWP, embodiments of the present invention suggest that for a given BS there exists a definition of an SL BWP with the resource pools defined within it, with each resource pool pertaining to a given zone. The system or network may have more than one SL BWP defined, where the SL BWPs have different numerologies, mapped to different use cases depending on the latency and reliability requirements. In accordance with embodiments, the system or network may have only a single SL BWP. In such embodiments, the definition of the BWP, e.g., in terms of bandwidth and/or numerology, may be the same for each zone, however, the actual SL resource pool configuration within the BWP may differ, e.g., from zone to zone.

The configuration of the BWP and the resource pools within them may include
a single configuration of a SL BWP with all resource pools defined within it, for all zones, or
multiple Configurations of a SL BWP with the resource pools defined within it, for all zones

In case of a single configuration, the UE may be provided with single BWP configuration for a given cell from the cell's BS. The configuration may contain the definition of all the resource pools within the BWP, and in case the zone concept is applied the NRzoneID may refer to the resource pool IDs defined within the BWP so that, based on the zone a UE is in, the UE may determine the resource pools which are relevant to the zone.

For example, a BWP-Sidelink information element as illustrated below may be used to define the SL BWP for UEs which are in RRC_IDLE/RRC_INACTIVE mode (bwp-Common) and RRC_CONNECTED mode (bwp-Dedicated). The bwp-Id is zero because there is only a single BWP configuration. This configuration may be broadcast within a cell via the system information block.

BWP-Sidelink information element

-- ASN1START
-- TAG-BWP-SIDELINK-START

| BWP-Sidelink ::= | | SEQUENCE { |
|---|---|---|
| | bwp-Id | BWP-Id, |

| | | |
|---|---|---|
| bwp-Common | BWP-SidelinkCommon | OPTIONAL, - |

- Cond SetupOtherBWP

| | | |
|---|---|---|
| bwp-Dedicated | BWP-SidelinkDedicated | OPTIONAL, -- |

Need M

...

}
-- TAG-BWP-SIDELINK-STOP
-- ASN1STOP

BWP-Sidelink field descriptions [Extract from TS 36.331]

bwp-Id
The ID corresponding to a SL BWP.
bwp-Common
Cell-specific SL BWP configuration.
bwp-Dedicated
UE-specific SL BWP configuration.

The resource pools may be defined using, e.g., a BWP-SidelinkCommon information element as shown below. The RPs are defined based on their IDs within pool lists, and the BWP is segregated into the resource pools for each zones in accordance with the above described segregation criteria. The definition of a resource pool may be given by SL-CommResourcePoolV2X.

BWP-SidelinkCommon information element

-- ASN1START
-- TAG-BWP-SIDELINKCOMMON-START

| | |
|---|---|
| BWP-SidelinkCommon ::= | SEQUENCE { |

| | |
|---|---|
| genericParameters | BWP, |

| | |
|---|---|
| SL-V2X-ConfigCommon ::= | SEQUENCE { |

| | | |
|---|---|---|
| v2x-CommRxPool | SL-CommRxPoolListV2X | OPTIONAL, - |

- Need OR

| | | |
|---|---|---|
| v2x-CommTxPoolNormalCommon | SL-CommTxPoolListV2X | OPTIONAL, - |

- Need OR

| | | |
|---|---|---|
| v2x-CommTxPoolExceptional | SL-CommResourcePoolV2X | OPTIONAL, - |

- Need OR
-- Any one or more combination/types of resource pool configuations based on the different
segregation criteria
}

...

}
-- TAG-BWP-SIDELINKCOMMON-STOP
-- ASN1STOP

BWP-SidelinkCommon field descriptions [Extract from TS 36.331]

SL-V2X-ConfigCommon
Contains all the different configurations for the transmit, receive and
exceptional pool types within a SL BWP broadcasted as system
information. This can also contain resource pools segregated based on
different criteria as mentioned earlier.

An example for a BWP-Sidelinkdedicated information element is illustrated, which may be used for a signaling for UE-specific resource configurations.

BWP-SidelinkDedicated information element

-- ASN1START

| | |
|---|---|
| SL-V2X-ConfigDedicated ::= | SEQUENCE { |

| | |
|---|---|
| commTxResources | CHOICE { |

| | |
|---|---|
| release | NULL, |
| setup | CHOICE { |

| | |
|---|---|
| scheduled | SEQUENCE { |

| | |
|---|---|
| sl-V-RNTI | C-RNTI, |

| | |
|---|---|
| mac-MainConfig | MAC-MainConfigSL, |

| | | | |
|---|---|---|---|
| v2x-SchedulingPool | SL-CommResourcePoolV2X | OPTIONAL, | -- Need |

ON

| | | | |
|---|---|---|---|
| mcs | INTEGER (0..31) | OPTIONAL, | -- Need OR |

| | |
|---|---|
| logicalChGroupInfoList | LogicalChGroupInfoList-r13 |

},

| | |
|---|---|
| ue-Selected | SEQUENCE { |

| -- Pool for normal usage | | | |
|---|---|---|---|
| v2x-CommTxPoolNormalDedicated SEQUENCE { | | | |
| poolToReleaseList | SL-TxPoolToReleaseListV2X | OPTIONAL, | -- Need |

ON

| | | | |
|---|---|---|---|
| poolToAddModList | SL-TxPoolToAddModListV2X | OPTIONAL, | -- Need |

ON

| | |
|---|---|
| v2x-CommTxPoolSensingConfig | SL-CommTxPoolSensingConfig |

| | |
|---|---|
| OPTIONAL | -- Need ON |

}

}

}

| } | | OPTIONAL, | -- Need ON |
|---|---|---|---|
| v2x-InterFreqInfoList | SL-InterFreqInfoListV2X | OPTIONAL, | -- Need ON |

| | | | |
|---|---|---|---|
| thresSL-TxPrioritization | SL-Priority | OPTIONAL, | -- Need OR |

| | | | |
|---|---|---|---|
| typeTxSync | SL-TypeTxSync | OPTIONAL, | -- Need |

OR

| | | | |
|---|---|---|---|
| cbr-DedicatedTxConfigList | SL-CBR-CommonTxConfigList | OPTIONAL, | -- Need |

OR

| ..., | | |
|---|---|---|
| [[ | commTxResources | CHOICE { |

| | |
|---|---|
| release | NULL, |
| setup | CHOICE { |

| scheduled | SEQUENCE { | | |
|---|---|---|---|
| logicalChGroupInfoList | LogicalChGroupInfoLis | OPTIONAL, | -- Need |

OR

| | | | |
|---|---|---|---|
| mcs-r15 | INTEGER (0..31) | OPTIONAL | -- Need |

OR

| }, | |
|---|---|
| ue-Selected | SEQUENCE { |

| | v2x-FreqSelectionConfigListSL-V2X-FreqSelectionConfigList-r15 |
|---|---|
| OPTIONAL | --Need OR |

}

| } | | |
|---|---|---|
| } | OPTIONAL, | -- Need ON |

]]

}

| | |
|---|---|
| LogicalChGroupInfoList-v1530 ::= | SEQUENCE (SIZE (1..maxLCG-r13)) OF |

SL-ReliabiIityList-r15

| | |
|---|---|
| SL-TxPoolToAddModListV2X ::= | SEQUENCE (SIZE (1.. maxSL-V2X-TxPool)) OF |

SL-TxPoolToAddMod

| SL-TxPoolToAddMod ::= | | SEQUENCE { |
|---|---|---|
| | poolIdentity | SL-V2X-TxPoolIdentity, |
| | pool | SL-CommResourcePoolV2X |

}

| | |
|---|---|
| SL-TxPoolToReleaseListV2X ::= | SEQUENCE (SIZE (1.. maxSL-V2X-TxPool)) OF SL- |

V2X-TxPoolIdentity
-- ASN1STOP

BWP-SidelinkDedicated field descriptions [Extract from TS 36.331]

SL- V2X-Dedicated
Contains all the different configurations for the transmit, receive and exceptional pool
types within a SL BWP which are dedicated resource pool configurations for a
particular UE. This can also contain resource pools segregated based on different
criteria as mentioned earlier.
commTxResources
Contains all the resource pool configuration for the transmit pool with ina SL BWP
and UE-specific.
logicalChGroupInfoList
Indicates for each logical channel group the list of associated priorities and reliabilities,
used as specified in TS 36.321 [6], in order of increasing logical channel group
identity. If E-UTRAN includes logicalChGroupInfoList-v1530, it includes the same
number of entries, and listed in the same order, as in logicalChGroupInfoList-r14, and
a logical channel group identity of the same entry in logicalChGroupInfoList-r14 and
in logicalChGroupInfo-v1530 is associated with both the priorties (as in
logicalChGroupInfoList-r14) and reliablities (as in logicalChGroupInfoList-v-1520) of
that entry. If logicalChGroupInfoList-v1530 is not included, this field indicates for
each logical channel group the list of associated priorties. These can correspond to
additional QoS parameters such as range, packet error rate.
mcs
Indicates the MCS as defined in TS 36.213 [23, 14.2.1]. If not configured, the selection
of MCS is up to UE implementation. If included, mcs-r15 corresponds to both the
MCS table in Table 8.6.1-1 in TS 36.213 [23] and the MCS table supporting 64QAM
in Table 14.1.1-2 in TS 36.213 [23] used for transmission on PSSCH.
scheduled
Indicates the configuration for the case E-UTRAN/NR Base station schedules the
transmission resources based on sidelink specific BSR from the UE.
sl-V-RNTI
Indicates the RNTI used for DCI dynamically scheduling sidelink resources for V2X
sidelink communication.
thresSL-TxPrioritization
Indicates the threshold used to determine whether SL V2X transmission is prioritized
over uplink transmission if they overlap in time (see TS 36.321 [6]). This value shall
overwrite thresSL-TxPrioritization configured in SIB21 or SL-V2X-Preconfiguration if
any.
typeTxSync
Indicates the prioritized synchronization type (i.e. eNB or GNSS) for performing V2X
sidelink communication on PCell.
ue-Selected
Indicates the configuration for the case the UE selects the transmission resources from
a pool of resources configured by E-UTRAN/NR-Base station within a SL BWP.
v2x-InterFreqInfoList
Indicates synchronization and resource allocation configurations of other carrier
frequencies than the serving carrier frequency for V2X sidelink communication. For
inter-carrier scheduled resource allocation. CIF = 1 in DCI-5A corresponds to the first
entry in this frequency list, CIF = 2 corresponds to the second entry, and so on (see TS
36.213 [23]). CIF = 0 in DCI-5A corresponds to the frequency where the DCI is
received.
v2x-SchedulingPool
Indicates a pool of resources when E-UTRAN/NR base station schedules Tx resources
for V2X sidelink communications.
SL-TxPoolIdentity
The IE identifies an individual pool entry within a SL BWP configured for sidelink
transmission, used for communication and discovery
SL-TxPoolToReleaseList
The IE SL-TxPoolToReleaseList is used to release one or more individual pool entries
within a SL BWP used for sidelink transmission, for communication and discovery
SL-CommTxPoolSensingConfig
The IE SL-CommTxPoolSensingConfig specifies V2X sidelink communication
configurations used for UE autonomous resource selection (Mode 2 in NR).

The BWP configuration may be indicated, for example, by a BWP information element as illustrated below, which may include a resource location, SCS and CP for the BWP.

BWP information element

-- ASN1START
-- TAG-BANDWIDTH-PART-START

| | |
|---|---|
| BWP ::= | SEQUENCE { |

| | |
|---|---|
| locationAndBandwidth | INTEGER (0..37949), |

| | |
|---|---|
| subcarrierSpacing | SubcarrierSpacing, |

| | | |
|---|---|---|
| cyclicPrefix | ENUMERATED { extended } | OPTIONAL -- |

Need R
}
-- TAG-BANDWIDTH-PART-STOP
-- ASN1STOP

BWP field descriptions [Extract from TS 36.331]

locationAndBandwidth
Frequency domain location and bandwidth of this bandwidth part. The value of the
field shall be interpreted as resource indicator value (RIV) as defined TS 38.214 with
assumptions as described in TS 38.213, section 12.
subcarrierSpacing
Subcarrier spacing to be used in this BWP for all channels and reference signals unless
explicitly configured elsewhere. Corresponds to subcarrier spacing according to
38.211, Table 4.2-1. The value kHz 15 corresponds to μ = 0, kHz 30 to μ = 1, and so on.
Only the values 15, 30, or 60 kHz (<6 GHz), and 60 or 120 kHz (>6 GHz) are
applicable. For the initial DL BWP this field has the same value as the field
subCarrierSpacingCommon in MIB of the same serving cell.
cyclicPrefix
Indicates whether to use the extended cyclic prefix for this bandwidth part. If not set,
the UE uses the normal cyclic prefix. Normal CP is supported for all numerologies and
slot formats. Extended CP is supported only for 60 kHz subcarrier spacing. (see
38.211, section 4.2.2)

The above-mentioned SL-CommResourcePoolV2X for defining the resource pool may be an information element, IE, as illustrated below. This exemplary IE defines the structure or configuration of a RP used for SL communication. The RPs may can be configured based on the designs described with reference to FIG. 11 to FIG. 14.

SL-CommResourcePool information element (4 IEs for each design)

-- ASN1START

| | |
|---|---|
| SL-CommResourcePoolV2X ::= | SEQUENCE { |

-- Across Time

| | |
|---|---|
| -- • | Bitmap across time, indicating the time slots/subframes where the resource pool is |

defined, spanning either a portion or the entire length of the BWP.

| | |
|---|---|
| -- • | Starting time slot/subframe and the duration of the resource pool. |
| -- • | Explicit time slot/subframe numbers. |

-- Across Frequency

| | |
|---|---|
| -- • | Bitmap across frequency, across the BWP. |
| -- • | Starting RB and number of RBs for a resource pool. |
| -- • | Multiple starting RB and ending RB, if the resource pool is non-contiguous over |

frequency, but defined in blocks of RBs.

| | |
|---|---|
| -- • | Explicit RB indices. |

-- Four types of design for the Resource Pool structure are defined
-- 1) Continuous over time and contiguous over frequency
-- 2) Continuous over time and non-contiguous over frequency
-- 3) Discontinuous over time and contiguous over frequency
-- 4) Discontinuous over time and non-contiguous over frequency
-- One or more of these parameters are used for the above 4 design types

| | | |
|---|---|---|
| sl-OffsetIndicator | SL-OffsetIndicator-r12 | OPTIONAL, -- Need |

OR

| | |
|---|---|
| sl-Subframe | SubframeBitmapSL-r14, |

| | |
|---|---|
| adjacencyPSCCH-PSSCH | BOOLEAN, |
| sizeSubchannel | ENUMERATED { |

n4, n5, n6, n8, n9, n10, n12, n15, n16, n18, n20, n25,

n30,

n48, n50, n72, n75, n96, n100, spare13, spare12,

spare11,

spare10, spare9, spare8, spare7, spare6, spare5,

spare4,

spare3, spare2, spare1},

| | |
|---|---|
| numSubchannel | ENUMERATED {n1, n3, n5, n8, n10, n15, n20, |

spare1},

| | |
|---|---|
| startRB-Subchannel | INTEGER (0..99), |

| | | |
|---|---|---|
| startRB-PSCCH-Pool | INTEGER (0..99) | OPTIONAL, -- |

Need OR

| | |
|---|---|
| rxParametersNCell | SEQUENCE { |

| | | |
|---|---|---|
| tdd-Config | TDD-Config | OPTIONAL, -- Need OP |

| | |
|---|---|
| syncConfigIndex | INTEGER (0..15) |

| } | | OPTIONAL, -- Need OR |
|---|---|---|
| dataTxParameters | SL-TxParameters | OPTIONAL, -- Cond Tx |

| | | |
|---|---|---|
| zoneID | INTEGER (0..7) | OPTIONAL, -- |

Need OR

| | | |
|---|---|---|
| poolReportId | SL-V2X-TxPoolReportIdentity | OPTIONAL,-- Need |

OR

| | | |
|---|---|---|
| resourceSelectionConfigP2X | SL-P2X-ResourceSelectionConfig | OPTIONAL,- |

- Cond P2X

| | |
|---|---|
| restrictResourceReservationPeriod | SL- |

| | |
|---|---|
| RestrictResourceReservationPeriodList | OPTIONAL,-- Need OR |

...

}

| | |
|---|---|
| SL-V2X-TxPoolReportIdentity-r14::= | INTEGER(1..maxSL-PoolToMeasure-r14) |

-- ASN1STOP

SL-CommResourcePool field descriptions [Extract from TS 36.331]

adjacencyPSCCH-PSSCH
Indicates whether a UE always transmits PSCCH and PSSCH in adjacent RBs
(indicated by TRUE) or it may transmit PSCCH and PSSCH in non-adjacent RBs
(indicated by FALSE). This parameter appears only when a pool is configured such
that a UE transmits PSCCH and the associated PSSCH in the same subframe.
sl-OffsetIndicator
Indicates the offset of the first subframe of a resource pool within a SFN cycle. If
absent, the resource pool starts from first subframe of SFN = 0. This field is not
applicable to V2X sidelink communication.
numSubchannel
Indicates the number of subchannels in the corresponding resource pool.
resourceSelectionConfigP2X
Indicates the allowed resource selection mechanism(s), i.e. partial sensing and/or
random selection, for P2X related V2X sidelink communication.
restrictResourceReservationPeriod
If configured, the field restrictResourceReservationPeriod configured in v2x-
ResourceSelectionConfig shall be ignored for transmission on this pool.
sizeSubchannel
Indicates the number of PRBs of each subchannel in the corresponding resource pool.
The value n5 denotes 5 PRBs; n6 denotes 6 PRBs and so on. The values n5, n6, n10,
n15, n20, n25, n50, n75 and n100 apply in the case of adjacencyPSCCH-PSSCH set to
TRUE; the values n4, n5, n6, n8, n9, n10, n12, n15, n16, n18, n20, n30, n48, n72 and
n96 apply in the case of adjacencyPSCCH-PSSCH set to FALSE.
poolReportId
The identity of the transmission resource pool used for CBR measurement reporting,
which is corresponding to the poolIdentity reported in measResultListCBR. This field is
only present in the transmission pools configured in RRCConnectionReconfiguration
and v2x-CommTxPoolExceptional, p2x-CommTxPoolNormalCommon, v2x-
CommTxPoolNormalCommon, v2x-CommTxPoolNormal in
SystemInformationBlockType21 or SystemInformationBlockType26. Otherwise, the
field is absent.
sl-Subframe
Indicates the bitmap of the resource pool, which is defined by repeating the bitmap
within a SFN cycle (see TS 36.213 [23]).
startRB-Subchannel
Indicates the lowest RB index of the subchannel with the lowest index.
startRB-PS CCH-Pool
Indicates the lowest RB index of the PSCCH pool.
thresSL-TxPrioritization
Indicates the threshold used to determine whether SL V2X transmission is prioritized
over uplink transmission if they overlap in time (see TS 36.321 [6]).
threshS-RSSI-CBR
Indicates the S-RSSI threshold for determining the contribution of a sub-channel to the
CBR measurement, as specified in TS 36.214 [48]. Value 0 corresponds to −112 dBm,
value 1 to −110 dBm, value n to (−112 + n*2) dBm, and so on.
tdd-Config
TDD configuration associated with the reception pool of the cell indicated by
syncConfigIndex. Absence of the field indicates that the duplex mode is FDD and no
TDD specific physical channel configuration is applicable.
syncConfigIndex
Indicates the synchronisation configuration that is associated with a reception pool, by
means of an index to the corresponding entry of commSyncConfig in
SystemInformationBlockType18 for sidelink communication, or by means of an index
to the corresponding entry of v2x-SyncConfig in SystemInformationBlockType21 or
SystemInformationBlockType26 for V2X sidelink communication.
v2x-CommRxPoolList
Indicates a list of reception pools for V2X sidelink communication.
v2x-CommTxPoolList
Indicates a list of transmission pools for V2X sidelink communication.
v2x-ResourceSelection Config
Indicates V2X sidelink communication configurations used for UE autonomous
resource selection.
zoneConfig
Indicates zone configurations used for V2X sidelink communication in 5.10.13.2.
zoneID
Indicates the zone ID for which the UE shall use this resource pool as described in
5.10.13.2. The field is absent in v2x-CommRxPoolList and p2x-CommTxPoolList in
SL-V2X-PreconfigFreqInfo.

In case of a multiple configurations, the UE may be provided with different BWP configurations for a given cell from the cell's BS. Each configuration may contain the definition of all the resource pools within the BWP, and in case the zone concept is applied the NRzoneID may refer to the resource pool IDs defined within the BWP so that, based on the zone a UE is in, the UE may determine the resource pools which are relevant to the zone. For example, a BWP-Sidelink information element as illustrated above may be used to define the SL BWP for UEs which are in RRC_IDLE/RRC_INACTIVE mode (bwp-Common) and RRC_CONNECTED mode (bwp-Dedicated). In this embodiment, the bwp-Id is not zero because there are multiple BWP configurations. The configurations may be broadcast within a cell via the system information block.

The above-mentioned BWP-Id may be an information element as illustrated below and may be used to identify the SL BWP and its associated RP configuration.

BWP-Id information element

| -- ASN1START | |
|---|---|
| -- TAG-BWP-ID-START | |
| BWP-Id ::= | INTEGER (0..maxNrofBWPs) |

-- TAG-BWP-ID-STOP
-- ASN1STOP

The above described embodiments for providing the SL BWP configuration to the UEs concerned the in-coverage cases. In accordance with other embodiments, for out-of-coverage cases, the SL BWP with the associated RP configurations may be stored (firmware) or hardcoded in the UEs or it may be pre-configured with a set of parameters. For example, a SL-V2X-Preconfiguration information element as shown below may be used for this.

SL-V2X-Preconfiguration information element

-- ASN1START
-- Resource can be defined as:
-- Across Time

| | |
|---|---|
| -- • | Bitmap across time, indicating the time slots/subframes where the resource pool is |

defined, spanning either a portion or the entire length of the BWP.

| | |
|---|---|
| -- • | Starting time slot/subframe and the duration of the resource pool. |
| -- • | Explicit time slot/subframe numbers. |

-- Across Frequency

| | |
|---|---|
| -- • | Bitmap across frequency, across the BWP. |
| -- • | Starting RB and number of RBs for a resource pool. |
| -- • | Multiple starting RB and ending RB, if the resource pool is non-contiguous over |
| | frequency, but defined in blocks of RBs. |
| -- • | Explicit RB indices. |

| | |
|---|---|
| SL-V2X-Preconfiguration ::= | SEQUENCE { |

...

}

| | |
|---|---|
| SL-V2X-PreconfigFreqInfo ::= | SEQUENCE { |

| BWP-SL-Common | |
|---|---|
| v2x-CommPreconfigGeneral | SL-PreconfigGeneral-r12, |

| v2x-CommPreconfigSync | SL-PreconfigV2X-Sync |
|---|---|
| OPTIONAL, | |
| v2x-CommRxPoolList | SL-PreconfigV2X-RxPoolList, |
| v2x-CommTxPoolList | SL-PreconfigV2X-TxPoolList, |
| p2x-CommTxPoolList | SL-PreconfigV2X-TxPoolList, |
| v2x-ResourceSelectionConfig | SL-CommTxPoolSensingConfig |

| OPTIONAL, | | |
|---|---|---|
| zoneConfig | SL-ZoneConfig | |
| OPTIONAL, | | |
| syncPriority | ENUMERATED {gnss, enb}, | |
| thresSL-TxPrioritization | SL-Priority | OPTIONAL, |
| offsetDFN | INTEGER (0..1000) | OPTIONAL, |

| ..., | |
|---|---|
| [[ v2x-FreqSelectionConfigList-r15 | SL-V2X-FreqSelectionConfigList-r15 |

OPTIONAL
]]

}

| | |
|---|---|
| SL-PreconfigV2X-RxPoolList ::= | SEQUENCE (SIZE (1..maxSL-V2X-RxPoolPreconf))OF |

SL-V2X-PreconfigCommPool

| | |
|---|---|
| SL-PreconfigV2X-TxPoolList ::= | SEQUENCE (SIZE (1..maxSL-V2X-TxPoolPreconf))OF |

SL-V2X-PreconfigCommPool
-- Pre-configured definition of 4 Design types of Resource Pool structures
-- 1) Continuous over time and contiguous over frequency
-- 2) Continuous over time and non-contiguous over frequency
-- 3) Discontinuous over time and contiguous over frequency
-- 4) Discontinuous over time and non-contiguous over frequency

| | |
|---|---|
| SL-V2X-PreconfigCommPool ::= | SEQUENCE { |

-- This IE is same as SL-CommResourcePoolV2X with rxParametersNCell absent

| sl-OffsetIndicator | SL-OffsetIndicator-r12 |
|---|---|
| OPTIONAL, | |
| sl-Subframe | SubframeBitmapSL, |

| | |
|---|---|
| adjacencyPSCCH-PSSCH | BOOLEAN, |
| sizeSubchannel | ENUMERATED { |

```
  n4, n5, n6, n8, n9, n10, n12, n15, n16, n18, n20, n25, n30,
  n48, n50, n72, n75, n96, n100, spare13, spare12, spare11,
  spare10, spare9, spare8, spare7, spare6, spare5, spare4,
  spare3, spare2, spare1},
```

| | |
|---|---|
| numSubchannel | ENUMERATED {n1, n3, n5, n8, n10, n15, n20, |

spare1},

| startRB-Subchannel | INTEGER (0..99), | |
|---|---|---|
| startRB-PSCCH-Pool | INTEGER (0..99) | OPTIONAL, |
| dataTxParameters | P0-SL-r12, | |
| zoneID | INTEGER (0..7) | |
| OPTIONAL, | | |
| threshS-RSSI-CBR | INTEGER (0..45) | OPTIONAL, |

| | |
|---|---|
| cbr-pssch-TxConfigList | SL-CBR-PPPP-TxPreconfigList |

| OPTIONAL, | | |
|---|---|---|
| resourceSelectionConfigP2X | SL-P2X-ResourceSelectionConfig | OPTIONAL, |

| | |
|---|---|
| syncAllowed | SL-SyncAllowed |

| OPTIONAL, | |
|---|---|
| restrictResourceReservationPeriod | SL-RestrictResourceReservationPeriodList |

OPTIONAL, -- Need OR
...,

}
END
-- ASN1STOP

SL-V2X-Preconfiguration field descriptions [Extract from TS 36.331]

adjacencyPSCCH-PSSCH
Indicates whether a UE always transmits PSCCH and PSSCH in adjacent RBs
(indicated by TRUE) or it may transmit PSCCH and PSSCH in non-adjacent RBs
(indicated by FALSE). This parameter appears only when a pool is configured such
that a UE transmits PSCCH and the associated PSSCH in the same subframe.
sl-OffsetIndicator
Indicates the offset of the first subframe of a resource pool within a SFN cycle. If
absent, the resource pool starts from first subframe of SFN = 0. This field is not
applicable to V2X sidelink communication.
numSubchannel
Indicates the number of subchannels in the corresponding resource pool.
resourceSelectionConfigP2X
Indicates the allowed resource selection mechanism(s), i.e. partial sensing and/or
random selection, for P2X related V2X sidelink communication.
restrictResourceReservationPeriod
If configured, the field restrictResourceReservationPeriod configured in v2x-
ResourceSelectionConfig shall be ignored for transmission on this pool.
sizeSubchannel
Indicates the number of PRBs of each subchannel in the corresponding resource pool.
The value n5 denotes 5 PRBs; n6 denotes 6 PRBs and so on. The values n5, n6, n10,
n15, n20, n25, n50, n75 and n100 apply in the case of adjacencyPSCCH-PSSCH set to
TRUE; the values n4, n5, n6, n8, n9, n10, n12, n15, n16, n18, n20, n30, n48, n72 and
n96 apply in the case of adjacencyPSCCH-PSSCH set to FALSE.
poolReportId
The identity of the transmission resource pool used for CBR measurement reporting,
which is corresponding to the poolIdentity reported in measResultListCBR. This field is
only present in the transmission pools configured in RRCConnectionReconfiguration
and v2x-CommTxPoolExceptional, p2x-CommTxPoolNormalCommon, v2x-
CommTxPoolNormalCommon, v2x-CommTxPoolNormal in
SystemInformationBlockType21 or SystemInformationBlockType26. Otherwise, the
field is absent.
sl-Subframe
Indicates the bitmap of the resource pool, which is defined by repeating the bitmap
within a SFN cycle (see TS 36.213 [23]).
startRB-Subchannel
Indicates the lowest RB index of the subchannel with the lowest index.
startRB-PSCCH-Pool
Indicates the lowest RB index of the PSCCH pool.
thresSL-TxPrioritization
Indicates the threshold used to determine whether SL V2X transmission is prioritized
over uplink transmission if they overlap in time (see TS 36.321 [6]).
threshS-RSSI-CBR
Indicates the S-RSSI threshold for determining the contribution of a sub-channel to the
CBR measurement, as specified in TS 36.214 [48], Value 0 corresponds to −112 dBm,
value 1 to −110 dBm, value n to (−112 + n*2) dBm, and so on.
tdd-Config
TDD configuration associated with the reception pool of the cell indicated by
syncConfigIndex. Absence of the field indicates that the duplex mode is FDD and no
TDD specific physical channel configuration is applicable.
syncConfigIndex
Indicates the synchronisation configuration that is associated with a reception pool, by
means of an index to the corresponding entry of commSyncConfig in
SystemInformationBlockType18 for sidelink communication, or by means of an index
to the corresponding entry of v2x-SyncConfig in SystemInformationBlockType21 or
SystemInformationBlockType26 for V2X sidelink communication.
v2x-CommRxPoolList
Indicates a list of reception pools for V2X sidelink communication.
v2x-CommTxPoolList
Indicates a list of transmission pools for V2X sidelink communication.
v2x-ResourceSelection Config
Indicates V2X sidelink communication configurations used for UE autonomous
resource selection.
zoneConfig
Indicates zone configurations used for V2X sidelink communication in 5.10.13.2.
zoneID
Indicates the zone ID for which the UE shall use this resource pool as described in
5.10.13.2. The field is absent in v2x-CommRxPoolList and p2x-CommTxPoolList in
SL-V2X-PreconfigFreqInfo.

In some of the embodiments described above, reference has been made to respective vehicles being either in the connected mode, also referred to as NR mode 1 configuration, or vehicles being in the idle mode, also referred to as NR mode 2 configuration. However, the present invention is not limited to V2V communications or V2X communications, rather it is also applicable to any device-to-device communications, for example non-vehicular mobile users or stationary users that perform a sidelink communication, e.g., over the PC5 interface. Also, in such scenarios, scheduling the resources in accordance with the aspects described above is advantageous as it allows for a more efficient scheduling of resources for sidelink communication avoiding resource collisions and the like.

Some embodiments of the present invention have been described above with reference to a communication system in which the transmitter is a base station serving a user equipment, and in which the receiver is the user equipment served by the base station. However, the present invention is not limited to such embodiments and may also be implemented in a communication system in which the transmitter is a user equipment, and in which the receiver is the base station serving the user equipment. In accordance with other embodiments, the receiver and the transmitter may both be UEs communicating directly with each other, e.g., via a sidelink interface.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments, a receiver may comprise one or more of a mobile or stationary terminal, an IoT device, a ground-based vehicle, an aerial vehicle, a drone, a building, or any other item or device provided with network connectivity enabling the item/device to communicate using the wireless communication system, like a sensor or actuator. In accordance with embodiments, a transmitter may comprise one or more of a macro cell base station, or a small cell base station, or a spaceborne vehicle, like a satellite or a space, or an airborne vehicle, like a unmanned aircraft system (UAS), e.g., a tethered UAS, a lighter than air UAS (LTA), a heavier than air UAS (HTA) and a high altitude UAS platforms (HAPs), or any transmission/reception point (TRP) enabling an item or a device provided with network connectivity to communicate using the wireless communication system.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

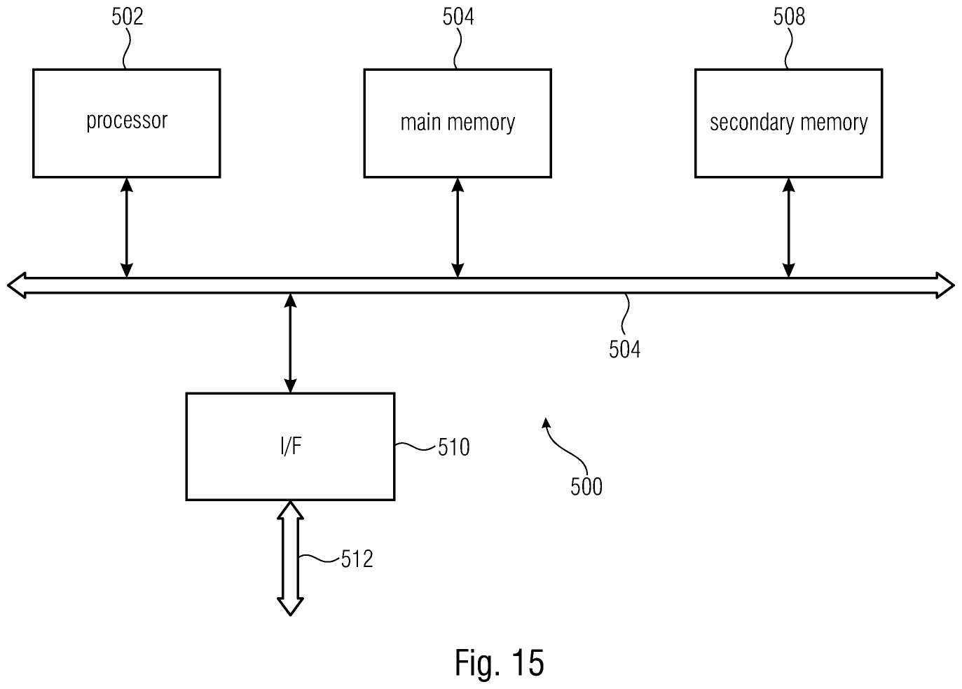

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 15 illustrates an example of a computer system 500. The units or modules as well as the steps of the methods performed by these units may execute on one or more computer systems 500. The computer system 500 includes one or more processors 502, like a special purpose or a general purpose digital signal processor. The processor 502 is connected to a communication infrastructure 504, like a bus or a network. The computer system 500 includes a main memory 506, e.g., a random access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### LIST OF ACRONYMS AND SYMBOLS

| | |
|---|---|
| V2X | Vehicle-to-Everything |
| 3GPP | Third Generation Partnership Project |
| D2D | Device-to-Device |
| ITS | Intelligent Transport Services |
| FR1, FR2 | Frequency Range Designations |
| BS | Base Station |
| eNB | Evolved Node B (3G base station) |
| UE | User Equipment |
| SL | Sidelink |
| V2V | Vehicle-to-Vehicle |
| SCS | Subcarrier Spacing |
| RB | Resource Block |
| PSCCH | Physical Sidelink Control Channel |
| PSSCH | Physical Sidelink Shared Channel |
| TTI | Transmit Time Interval |
| SCI | Sidelink Control Information |
| DCI | Downlink Control Information |
| CP | Cyclic Prefix |
| BWP | Bandwidth Part |
| CORESET | Control Resource Set |
| USS | UE-Specific Search Space |
| CSS | Common Search Space |
| RP | Resource Pool |

1. A transceiver for a wireless communication system, the wireless communication system providing resources to be allocated for respective transmissions in the wireless communication system, wherein
the resources comprise one or more bandwidth parts, BWPs, a BWP comprising a certain numerology and comprising a plurality of subcarriers in the frequency domain,
at least one of the BWPs comprises a plurality of resource sets for a sidelink communication, the plurality of resource sets comprising at least a first resource set and a second resource set, the first resource set being associated with a first criterium, the second resource set being associated with a second criterium, and the first criterium and the second criterium being different, and
the transceiver is configured to use resources from one or more of the plurality of resource sets within the one BWP for a communication.

2. The transceiver of claim 1, wherein the first and second criteria comprise one or more of the following:
a communication type, e.g. unicast, groupcast/multicast or broadcast,
a traffic type, e.g. aperiodic/one shot or periodic/SPS,
an operation mode, e.g. Mode 1 (in coverage) or Mode 2 (out of coverage),
a QoS requirement, e.g. priority, latency, reliability or communication range,
a zonal location, e.g. zone ID, a geographical grid, routes or special points of interests, like crossings).

3. The transceiver of claim 1, wherein a plurality of different resource sets are defined within the one BWP for different communication types having associated therewith different reliability and latency requirements, the communication types comprising one or more of a broadcast, a groupcast, a multicast or a unicast communication.

4. The transceiver of claim 1, wherein a first resource set is defined within the one BWP for Mode 1 UEs, and a second resource set is defined within the one BWP for Mode 2 UEs.

5. The transceiver of claim 1, wherein the resource sets are defined within the one BWP in one or more of the following manners:
continuous over time and contiguous over frequency,
continuous over time and non-contiguous over frequency,
discontinuous over time and contiguous over frequency,
discontinuous over time and non-contiguous over frequency.

6. The transceiver of claim 5, wherein in case of a resource set being discontinuous over time and contiguous over frequency, across time at least some of the resources, like time slots or subframes, are discontinuous and are not adjacent to each, and across frequency the resources, like resource blocks, RBs, are contiguous and adjacent to each other.

7. The transceiver of claim 1, wherein some of the resource sets defined within the one BWP partially overlap each other.

8. The transceiver of claim 1, wherein
the resource sets are defined across time in any one of the following manners:
by a bitmap across time, the bitmap indicating resources, like OFDM symbols or time slots or subframes or frames, where the resource set is defined, spanning either a portion or the entire length of the one BWP,
by a starting resource, like a time slot or a subframe, and a duration of the resource set,
by explicit resources numbers, like time slot or subframe numbers,
by puncturing out resources mentioned explicitly or that are part of another set of resources or RP, and
by a starting resource, and periodic offsets for subsequent occurrences, and
wherein the resource sets are defined across frequency in any one of the following manners:
by a bitmap, the bitmap the bitmap indicating resources, like resource blocks, across the one BWP,
by a starting resource, like a resource block, and a number of resources for a resource set,
by multiple starting resources, like resource blocks, and ending resources, if the resource set is non-contiguous over frequency,
by explicit resource indices, like resource block indices,
by puncturing out resources mentioned explicitly or that are part of another set of resources or RP, and
by a starting resource, and periodic offsets for subsequent occurrences.

9. The transceiver of claim 1, wherein, in case the transceiver is in-coverage, the transceiver is configured to
receive for all zones a single BWP configuration with all resource sets defined within the one BWP, e.g., using Uu or PC5 RRC signaling, and/or
receive for each zone a BWP configuration with resource sets defined within the one BWP, e.g., using Uu or PC5 RRC signaling, and
wherein, in case the transceiver is out-of-coverage, the transceiver is configured to retain a last BWP configuration received from a gNB or to revert to a default or hardcoded BWP configuration or to select one of previously retained BWP configurations.

10. The transceiver of claim 9, wherein, in case the transceiver is out-of-coverage, the transceiver is configured to operate using a BWP pre-configuration defining the different resources sets across time and frequency within the one BWP and a numerology of the one BWP.

11. The transceiver of claim 1, wherein a resource set defines a resource pool or a mini-resource pool, wherein a mini-resource pool may define a subpool of the set of resources or RP, the mini-resource pool comprising less time and/or frequency resources than a RP.

12. A transceiver for a wireless communication system, the transceiver for serving a plurality of user equipments, UEs, located in a coverage area of the transceiver, wherein
the transceiver configures for its coverage area at least one bandwidth part, BWP, comprising a certain numerology and comprising a plurality of subcarriers in the frequency domain, the at least one BWP comprising a plurality of resource sets for a sidelink communication among UEs, the plurality of resource sets comprising at least a first resource set and a second resource set, the first resource set being associated with a first criterium, the second resource set being associated with a second criterium, and the first criterium and the second criterium being different.

13. A wireless communication system, comprising
a plurality of the transceivers configured to communicate with each other using a sidelink, SL, and
at least one bandwidth part, BWP, comprising a certain numerology and comprising a plurality of subcarriers in the frequency domain, the at least one BWP comprising a plurality of resource sets for the sidelink communication among the transceivers, the plurality of resource sets comprising at least a first resource set and a second resource set, the first resource set being associated with a first criterium, the second resource set being associated with a second criterium, and the first criterium and the second criterium being different.

14. A wireless communication system, comprising:
one or more base stations, BS, and one or more user equipments, UEs, a UE being configured for a sidelink, SL, communication with one or more other UEs,
wherein a base station and/or a UE comprises a transceiver,
wherein the wireless communication system providing resources to be allocated for respective transmissions in the wireless communication system,
wherein the resources comprise one or more bandwidth parts, BWPs, a BWP comprising a certain numerology and comprising a plurality of subcarriers in the frequency domain,
wherein at least one of the BWPs comprises a plurality of resource sets for a sidelink communication, the plurality of resource sets comprising at least a first resource set and a second resource set, the first resource set being associated with a first criterium, the second resource set being associated with a second criterium, and the first criterium and the second criterium being different, and
wherein the transceiver is configured to use resources from one or more of the plurality of resource sets within the one BWP for a communication.

15. A method for operating a wireless communication system, the method comprising:
providing resources to be allocated for respective transmissions in the wireless communication system, wherein the resources comprise one or more bandwidth parts, BWPs, a BWP comprising a certain numerology and comprising a plurality of subcarriers in the frequency domain,
providing at least one of the BWPs which comprises a plurality of resource sets for a sidelink communication, the plurality of resource sets comprising at least a first resource set and a second resource set, the first resource set being associated with a first criterium, the second resource set being associated with a second criterium, and the first criterium and the second criterium being different, and
using resources from one or more of the plurality of resource sets within the one BWP for the sidelink communication among a plurality of user devices, UEs, of the wireless communication system.

16. A non-transitory computer program product comprising a computer readable medium storing instructions which, when executed on a computer, perform a method for operating a wireless communication system, the method comprising:
providing resources to be allocated for respective transmissions in the wireless communication system, wherein the resources comprise one or more bandwidth parts, BWPs, a BWP comprising a certain numerology and comprising a plurality of subcarriers in the frequency domain,
providing at least one of the BWPs which comprises a plurality of resource sets for a sidelink communication, the plurality of resource sets comprising at least a first resource set and a second resource set, the first resource set being associated with a first criterium, the second resource set being associated with a second criterium, and the first criterium and the second criterium being different, and
using resources from one or more of the plurality of resource sets within the one BWP for the sidelink communication among a plurality of user devices, UEs, of the wireless communication system.
